(19) United States
(12) Patent Application Publication
(10) Pub. No.: US 2024/0062084 A1
(43) Pub. Date: Feb. 22, 2024

(54) INFORMATION PROCESSING APPARATUS AND INFORMATION PROCESSING METHOD

(71) Applicant: Mitsubishi Electric Corporation, Tokyo (JP)

(72) Inventor: Hiroshi KAGE, Tokyo (JP)

(73) Assignee: Mitsubishi Electric Corporation, Tokyo (JP)

(21) Appl. No.: 18/269,572

(22) PCT Filed: Jan. 15, 2021
(86) PCT No.: PCT/JP2021/001143

§ 371 Date: Jun. 26, 2023

(51) Int. Cl. G06N 5/04; G06N 5/025

(52) U.S. Cl. CPC G06N 5/041; G06N 5/025

(57) ABSTRACT

In order to give an answer to a user even if information necessary for reaching the answer cannot be obtained, an information processing apparatus includes: a construction unit to construct an output logical expression on the basis of an inference rule related to a search logical expression in which a question sentence is described by predicate logic; and a generation unit to generate an answer sentence from the output logical expression.

### TECHNICAL FIELD

The present disclosed technology relates to an information processing apparatus and an information processing method.

### BACKGROUND ART

The question answering apparatus that responds to a question from a user described in Patent Literature 1 asks a question back to the user in order to obtain, from the user, information necessary for reaching an answer that can be given to the user.

### CITATION LIST

### Patent Literature

Patent Literature 1: WO 2019/239543 A

### SUMMARY OF INVENTION

### Technical Problem

However, when the user does not give the necessary information to the question answering apparatus regarding the above question back, the question answering apparatus cannot obtain the necessary information. As a result, since the question answering apparatus cannot reach the above answer, it cannot give an answer to the user.

An object of the present disclosed technology is to give an answer to a user even if information necessary for reaching an answer cannot be obtained.

### Solution to Problem

In order to solve the above problem, an information processing apparatus according to the present disclosed technology includes: a construction unit to construct an output logical expression on a basis of an inference rule related to a search logical expression in which a question sentence is described by predicate logic; and a generation unit to generate an answer sentence from the output logical expression.

### Advantageous Effects of Invention

According to the information processing apparatus according to the present disclosed technology, an answer can be given to the user even if information necessary for reaching the answer cannot be obtained.

### BRIEF DESCRIPTION OF DRAWINGS

FIG. 1 is a functional block diagram of an information processing apparatus 1 according to a first embodiment.

FIG. 2 illustrates a configuration of the information processing apparatus 1 of the first embodiment.

FIG. 3 is a block diagram illustrating an operation of the information processing apparatus 1 of the first embodiment.

FIG. 4 is a flowchart illustrating the operation of the information processing apparatus 1 of the first embodiment.

FIG. 5 is a functional block diagram of an information processing apparatus 2 according to a second embodiment.

FIG. 6 is a block diagram illustrating an operation of the information processing apparatus 2 of the second embodiment.

FIG. 7 is a flowchart illustrating the operation of the information processing apparatus 2 of the second embodiment.

FIG. 8 is a functional block diagram of an information processing apparatus 3 according to a third embodiment.

FIG. 9 is a functional block diagram of a processing unit 38 of the third embodiment.

FIG. 10 is a block diagram illustrating an operation of the information processing apparatus 3 of the third embodiment.

FIG. 11 is a flowchart illustrating the operation of the information processing apparatus 3 of the third embodiment.

FIG. 12 is a functional block diagram of an information processing apparatus 4 according to a fourth embodiment.

FIG. 13 is a functional block diagram of a processing unit 48 of the fourth embodiment.

FIG. 14 is a block diagram illustrating an operation of the information processing apparatus 4 of the fourth embodiment.

FIG. 15 is a flowchart illustrating the operation of the information processing apparatus 4 of the fourth embodiment.

FIG. 16 is a functional block diagram of an information processing apparatus 5 according to a fifth embodiment.

FIG. 17 is a functional block diagram of a processing unit 58 of the fifth embodiment.

FIG. 18 is a block diagram illustrating an operation of the information processing apparatus 5 of the fifth embodiment.

FIG. 19 is a flowchart illustrating the operation of the information processing apparatus 5 of the fifth embodiment.

FIG. 20 is a functional block diagram of an information processing apparatus 6 according to a sixth embodiment.

FIG. 21 is a functional block diagram of a processing unit 68 of the sixth embodiment.

FIG. 22 is a block diagram illustrating an operation of the information processing apparatus 6 of the sixth embodiment.

FIG. 23 is a flowchart (part 1) illustrating the operation of the information processing apparatus 6 of the sixth embodiment.

FIG. 24 is a flowchart (part 2) illustrating the operation of the information processing apparatus 6 of the sixth embodiment.

### DESCRIPTION OF EMBODIMENTS

Some embodiments of an information processing apparatus according to the present disclosed technology will be described.

### First Embodiment

An information processing apparatus 1 according to a first embodiment will be described.

### Configuration of First Embodiment

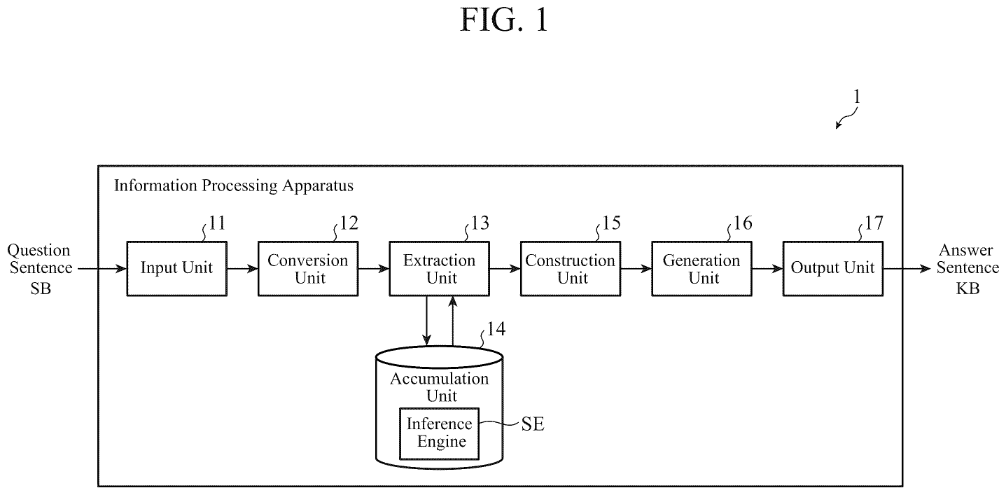

FIG. 1 is a functional block diagram of the information processing apparatus 1 of the first embodiment.

The information processing apparatus 1 of the first embodiment is used in, for example, a dialogue system. More specifically, as illustrated in FIG. 1, the information processing apparatus 1 of the first embodiment includes an input unit 11, a conversion unit 12, an extraction unit 13, an accumulation unit 14, a construction unit 15, a generation unit 16, and an output unit 17 in order to output a sentence KB of an answer (hereinafter, an answer sentence) for a sentence SB input in a dialogue form from a user (hereinafter, referred to as a “question sentence”).

The “conversion unit 12” corresponds to an “acquisition unit” and a “conversion unit”, the “extraction unit 13” corresponds to an “extraction unit”, the “construction unit 15” corresponds to a “construction unit”, and the “generation unit 16” corresponds to a “generation unit”.

Furthermore, the “conversion unit 12”, the “extraction unit 13”, and the “construction unit 14” correspond to a “construction unit”, and the “generation unit 16” corresponds to a “generation unit”.

The “question sentence” corresponds to the “sentence of a question”, and the “answer sentence” corresponds to the “sentence of an answer”.

The question sentence SB and the answer sentence KB are described in a natural language. In the question sentence SB and the answer sentence KB, the sentence means a broad concept including a simple sentence. The question sentence SB and the answer sentence KB may include a plurality of sentences or may include one sentence.

In the following description, a logical expression such as “resign (Steve, Company ABC)” is an atomic logical expression. A relationship between two atomic logical expressions such as “resign (X, Y)→get (X, money)”, that is, a relationship such as “the former leads to the latter” is an inference rule. In the inference rule, the former is an “assumption part”, and the latter is a “consequence part”.

For example, “X” and “Y” in the atomic logical expression “resign (X, Y)” are variables, the first variable “X” represents a subject of the predicate “resign”, and the second variable “Y” represents an object of the predicate “resign”.

The input unit 11 is used by a user (not shown) to input the question sentence SB to the information processing apparatus 1. The question sentence SB is, for example, an affirmative sentence “Steve resigns Company ABC.” for asking a question about an item related to “Steve is quitting the company ABC”.

The conversion unit 12 converts the question sentence SB described in the natural language into a search logical expression KR under predicate logic. For example, the conversion unit 12 converts the question sentence SB “Steve resigns Company ABC.” acquired via the input unit 11 into the search logical expression KR “resign (Steve, Company ABC)”.

The search logical expression KR is an atomic logical expression used by the extraction unit 13 to search in the accumulation unit 14.

The extraction unit 13 searches in the accumulation unit 14 on the basis of the search logical expression KR. As a result, the extraction unit 13 extracts an inference rule SK related to the search logical expression KR. The extraction unit 13 extracts, for example, the inference rule SK “resign (X, Y)→get (X, money)” related to the search logical expression KR “resign (Steve, Company ABC)”.

As illustrated in FIG. 1, an inference engine SE is used when the extraction unit 13 performs search and extraction in the accumulation unit 14.

Further, the extraction unit 13 collates the search logical expression KR with the inference rule SK to derive a solution of a variable common between the search logical expression KR and the inference rule SK (hereinafter, such a solution of the variable is simply referred to as a “solution”). For example, the extraction unit 13 collates the search logical expression KR “resign (Steve, Company ABC)” with the assumption part “resign (X, Y)” of the inference rule SK “resign (X, Y)→get (X, money)” to derive the solution “X=Steve”.

The accumulation unit 14 stores the inference rule SK in advance as knowledge.

The construction unit 15 constructs an output logical expression SR from the inference rule SK.

The output logical expression SR is an atomic logical expression used by the generation unit 16 to generate the answer sentence KB described in a natural language.

For example, the construction unit 15 constructs an output logical expression SR “get (Steve, money)” corresponding to the consequence part of the inference rule SK “resign (X, Y)→get (X, money)” by substituting the solution “X=Steve” into the inference rule SK “resign (X, Y)→get (X, money)”.

The generation unit 16 generates the answer sentence KB in a natural language from the output logical expression SR described by predicate logic. For example, the generation unit 16 generates the answer sentence KB “Steve gets money.” on the basis of the output logical expression SR “get (Steve, money)”.

The output unit 17 outputs the answer sentence KB to the user. The output unit 17 outputs, for example, the answer sentence KB “Steve gets money.” to the user.

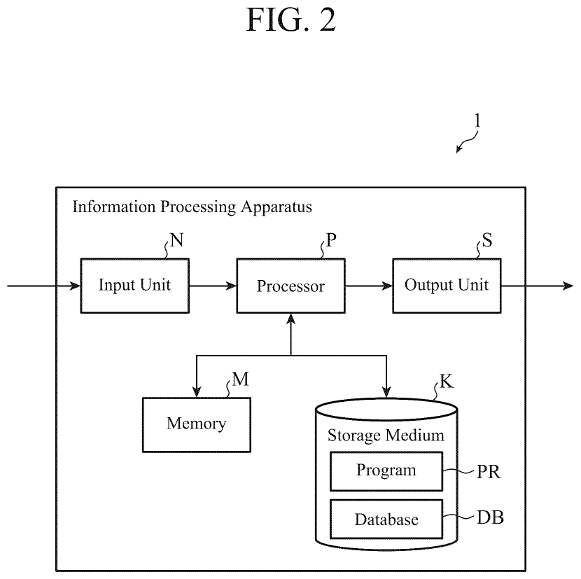

FIG. 2 illustrates a configuration of the information processing apparatus 1 of the first embodiment.

As illustrated in FIG. 2, the information processing apparatus 1 includes an input unit N, a processor P, an output unit S, a memory M, and a storage medium K.

The input unit N includes, for example, a microphone, a keyboard, a mouse, and a touch panel. The processor P is, for example, a central processing unit (CPU), and is a core of a well-known computer that operates hardware according to software. The output unit S includes, for example, a speaker, a liquid crystal monitor, and a printer. The memory M includes, for example, a dynamic random access memory (DRAM) and a static random access memory (SRAM). The storage medium K includes, for example, a hard disk drive (HDD), a solid state drive (SSD), and a read only memory (ROM).

The storage medium K stores a program PR and a database DB. The program PR is a command group that defines contents of processing to be executed by the processor P. The database DB stores, for example, the inference rule SK described above.

Regarding the relationship between hardware and functions in the information processing apparatus 1, the processor P executes the program PR stored in the storage medium K using the memory M while the input unit N and the output unit S exchange information with the user as the input unit 11 and the output unit 17, thereby implementing the functions of the respective units of the conversion unit 12 to the generation unit 16.

### Operation of First Embodiment

An operation of the information processing apparatus 1 according to the first embodiment will be described.

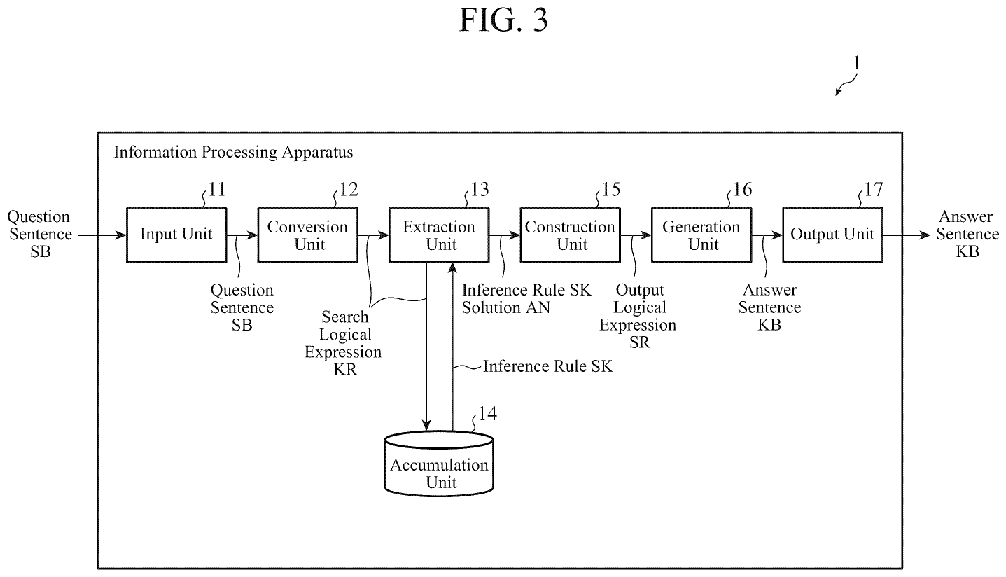

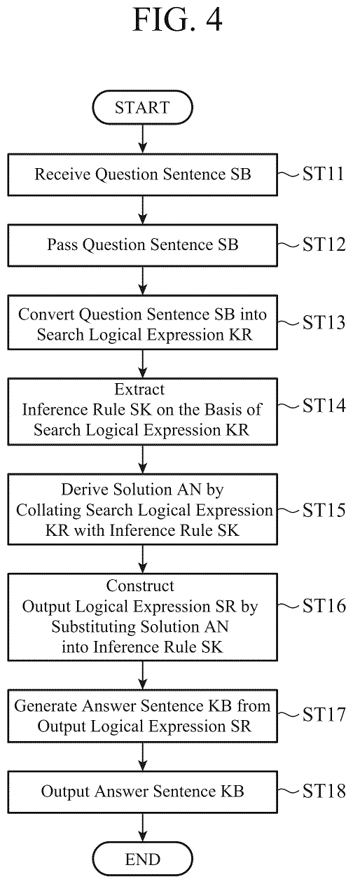

FIG. 3 is a block diagram illustrating the operation of the information processing apparatus 1 according to the first embodiment. FIG. 4 is a flowchart illustrating the operation of the information processing apparatus 1 according to the first embodiment.

Hereinafter, the operation of the information processing apparatus 1 of the first embodiment will be described with reference to the block diagram of FIG. 3 and the flowchart of FIG. 4.

In order to facilitate description and understanding, sentences, logical expressions, and the like are listed in advance below.

Question sentence SB: Steve resigns Company ABC.
Search logical expression KR: resign (Steve, Company ABC)
Inference rule SK: resign (X, Y)→get (X, money)
Solution AN: X=Steve
Output logical expression SR: get (Steve, money)
Answer sentence KB: Steve gets money.

Step ST11: The input unit 11, which is the input unit N such as a microphone or a keyboard, receives an input of the question sentence SB “Steve resigns Company ABC” from the user.

Step ST12: When the question sentence SB “Steve resigns Company ABC” is input in step ST11, the input unit 11 passes the question sentence SB “Steve resigns Company ABC” to the conversion unit 12.

Step ST13: When the question sentence SB “Steve resigns Company ABC” is delivered from the conversion unit 12 in step ST12, the conversion unit 12, which is the processor P, converts the question sentence SB “Steve resigns Company ABC” into the search logical expression KR “resign (Steve, Company ABC)” under the predicate logic. The conversion unit 12 outputs the search logical expression KR “resign (Steve, Company ABC)” to the extraction unit 13.

Step ST14: When the search logical expression KR “resign (Steve, Company ABC)” is output from the conversion unit 12 in step ST13, the extraction unit 13, which is the processor P, searches in the accumulation unit 14, which is the storage medium K, on the basis of the search logical expression KR “resign (Steve, Company ABC)”. As a result, the extraction unit 13 extracts the inference rule SK “resign (X, Y)→get (X, money)” related to the search logical expression KR “resign (Steve, Company ABC)” by the inference engine SE.

Step ST15: When the inference rule SK “resign (X, Y)→get (X, money)” is extracted in step ST14, the extraction unit 13 also collates the search logical expression KR “resign (Steve, Company ABC)” with the assumption part “resign (X, Y)” of the inference rule SK “resign (X, Y)→get (X, money)” to derive the solution AN “X=Steve”.

The extraction unit 13 outputs the inference rule SK “resign (X, Y)→get (X, money)” and the solution AN “X=Steve” to the construction unit 15.

Step ST16: When the inference rule SK “resign (X, Y)→get (X, money)” and the solution AN “X=Steve” are output from the extraction unit 13 in step ST15, the construction unit 15, which is the processor P, constructs the output logical expression SR “get (Steve, money)” by substituting the solution AN “X=Steve” into the consequence part “get “(X, money)” of the inference rule SK “resign (X, Y)→get (X, money)”. The construction unit 15 outputs the output logical expression SR “get (Steve, money)” to the generation unit 16.

Step ST17: When the output logical expression SR “get (Steve, money)” is output from the construction unit 15 in step ST16, the generation unit 16, which is the processor P, generates the answer sentence KB “Steve gets money.” from the output logical expression SR “get (Steve, money)”. The generation unit 16 outputs the answer sentence KB “Steve gets money.” to the output unit 17.

Step ST18: When the answer sentence KB “Steve gets money.” is output from the generation unit 16 in step ST17, the output unit 17, which is the output unit S such as a speaker or a liquid crystal monitor, outputs the answer sentence KB “Steve gets money.” to the user.

### Effects of First Embodiment

According to the information processing apparatus 1 of the first embodiment, the conversion unit 12 converts the question sentence SB “Steve resigns Company ABC.” input from the input unit 11 into the search logical expression KR “resign (Steve, Company ABC)”. The extraction unit 13 searches in the accumulation unit 14 in which the inference rule SK is accumulated, on the basis of the search logical expression KR “resign (Steve, Company ABC)” to extract the inference rule SK “resign (X, Y)→get (X, money)” related to the search logical expression KR “resign (Steve, Company ABC)”, and passes the inference rule SK “resign (X, Y)→get (X, money)” and the solution AN “X=Steve” to the construction unit 15. The construction unit 15 constructs the output logical expression SR “get (Steve, money)” from the inference rule SK “resign (X, Y)→get (X, money)” and the solution AN “X=Steve”. The generation unit 16 generates the answer sentence KB “Steve gets money.” from the output logical expression SR “get (Steve, money)”. The output unit 17 outputs the answer sentence KB “Steve gets money.” to the user.

As a result, in order to obtain the answer sentence KB for the question sentence SB from the user, the information processing apparatus 1 can give the answer sentence KB to the user without asking the user to obtain information necessary for reaching the answer sentence KB from the question sentence SB, more specifically, information “money, person, or article?”, “obtain or lose?”, and the like related to “resign” in the question sentence SB.

### <Modifications>

The information processing apparatus 1 of the first embodiment can also be used, for example, in a machine translation system or a network search system instead of the dialogue system described above.

The inference rule SK stored in the accumulation unit 14 may be added and updated as needed in addition to being stored in advance.

The accumulation unit 14 may be constructed in a form of being connected to a network (for example, a centralized management database system, a distributed management database system), or may be constructed in a form of being not connected to any network (for example, standalone database equipment).

### Document related to First embodiment

Techniques described in the following document can be used for conversion and generation between the natural language and the predicate logic in the conversion unit 12 and the generation unit 16.

Hinaut, X. et al., “Cortico-Striatal Response Selection in Sentence Production: Insights from neural network simulation with Reservoir Computing.”, Brain and Language, vol. 150, November 2015, pp. 54-68.

For example, the sentence in the natural language and the expression of the predicate logic corresponding to the sentence in the natural language are vectorized by 0/1, and then the above-described conversion and generation are learned by the recursive neural circuit “Echo State Network”, whereby the above-described conversion and generation can be programmed.

It is widely known that the inference engine SE is constructed using the language Prolog, for example, in the following document and the like.

U.S. Pat. No. 8,180,758, “Data management system utilizing predicate logic”, Amazon Technologies, Inc.

### Second Embodiment

An information processing apparatus according to a second embodiment will be described. In the first embodiment, the question sentence SB is an “affirmative sentence”, whereas in the second embodiment, the question sentence SB is an “interrogative sentence”.

### Configuration of Second Embodiment

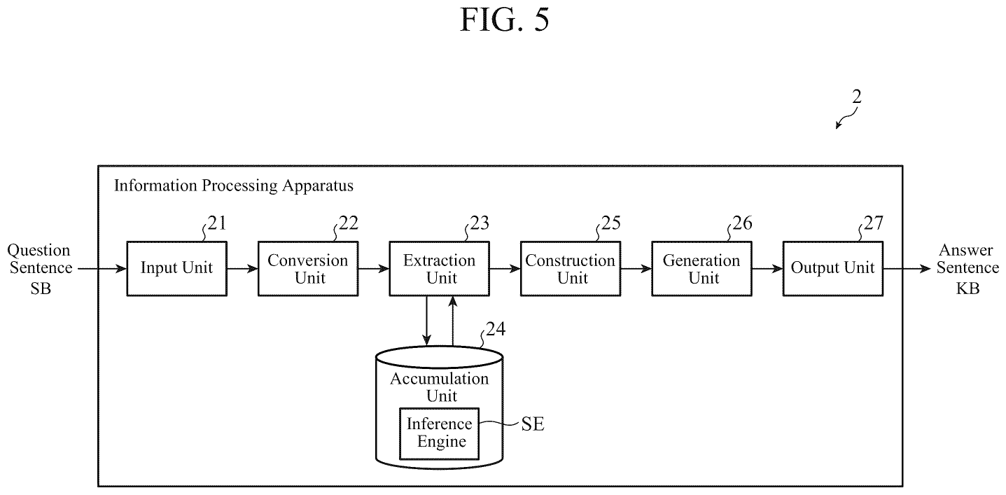

FIG. 5 is a functional block diagram of an information processing apparatus 2 according to the second embodiment.

As illustrated in FIG. 5, similarly to the information processing apparatus 1 (FIG. 1) of the first embodiment, the information processing apparatus 2 of the second embodiment includes an input unit 21, a conversion unit 22, an extraction unit 23, an accumulation unit 24, a construction unit 25, a generation unit 26, and an output unit 27.

Here, the input unit 21 corresponds to the input unit 11 of the first embodiment, the conversion unit 22 corresponds to the conversion unit 12 of the first embodiment, the extraction unit 23 corresponds to the extraction unit 13 of the first embodiment, the accumulation unit 24 corresponds to the accumulation unit 14 of the first embodiment, the construction unit 25 corresponds to the construction unit 15 of the first embodiment, the generation unit 26 corresponds to the generation unit 16 of the first embodiment, and the output unit 27 corresponds to the output unit 17 of the first embodiment.

The configuration of the information processing apparatus 2 of the second embodiment is similar to the configuration of the information processing apparatus 1 of the first embodiment (FIG. 2).

### Operation of Second Embodiment

An operation of the information processing apparatus 2 according to the second embodiment will be described.

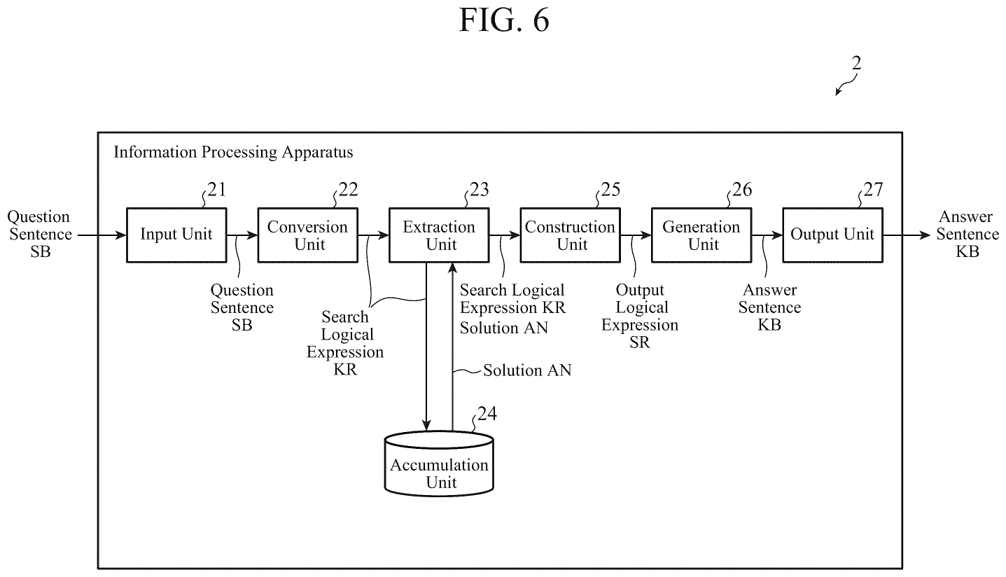

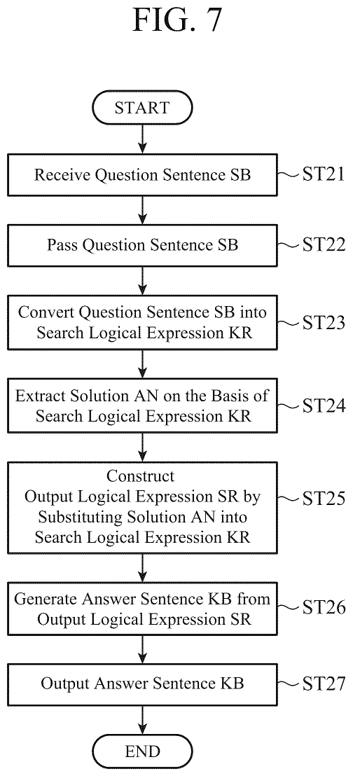

FIG. 6 is a block diagram illustrating the operation of the information processing apparatus 2 according to the second embodiment. FIG. 7 is a flowchart illustrating the operation of the information processing apparatus 2 according to the second embodiment.

Hereinafter, the operation of the information processing apparatus 2 of the second embodiment will be described with reference to the block diagram of FIG. 6 and the flowchart of FIG. 7.

In order to facilitate description and understanding, sentences, logical expressions, and the like are listed in advance below.

Question sentence SB: Who resigns Company ABC?
Search logical expression KR: resign (X, Company ABC)
Solution AN: X=Steve
Output logical expression SR: resign (Steve, Company ABC)
Answer sentence KB: Steve resigns Company ABC.

Step ST21: The input unit 21 receives an input of the question sentence SB “Who resigns Company ABC?” as an interrogative sentence from a user.

Step ST22: When the question sentence SB “Who resigns Company ABC?” is input in step ST21, the input unit 21 passes the question sentence SB “Who resigns Company ABC?” to the conversion unit 22.

Step ST23: When the question sentence SB “Who resigns Company ABC?” is delivered from the conversion unit 22 in step ST22, the conversion unit 22 converts the question sentence SB “Who resigns Company ABC?” into the search logical expression KR “resign (X, Company ABC)” under the predicate logic. The conversion unit 22 outputs the search logical expression KR “resign (X, Company ABC)” to the extraction unit 23.

Here, unlike the first embodiment, the conversion unit 22 analyzes an attribute (for example, whether or not it is an interrogative word) of the word (who, resign, etc.) in the question sentence SB “Who resigns Company ABC?” as the interrogative sentence. As a result, the conversion unit 22 converts the question sentence SB into the search logical expression KR “resign (X, Company ABC)” by replacing the interrogative word “who”, that is, the word “who” indicating the unknown target with the variable “X”.

Step ST24: When the search logical expression KR “resign (X, Company ABC)” is output from the conversion unit 22 in step ST23, the extraction unit 23 searches in the accumulation unit 24 on the basis of the search logical expression KR “resign (X, Company ABC)”.

Here, unlike the first embodiment, the extraction unit 23 extracts, for example, the solution AN “X=Steve” related to the search logical expression KR “resign (X, Company ABC)” by the inference engine SE.

The extraction unit 23 outputs the search logical expression KR “resign (X, Company ABC)” and the solution AN “X=Steve” to the construction unit 25.

Step ST25: When the search logical expression KR “resign (X, Company ABC)” and the solution AN “X=Steve” are output from the extraction unit 23 in step ST24, the construction unit 25 constructs the output logical expression SR “resign (Steve, Company ABC)” by substituting the solution AN “X=Steve” into the search logical expression KR “resign (X, Company ABC)”. The construction unit 25 outputs the output logical expression SR “resign (Steve, Company ABC)” to the generation unit 26.

Step ST26: When the output logical expression SR “resign (Steve, Company ABC)” is output from the construction unit 25 in step ST25, the generation unit 26 generates the answer sentence KB “Steve resigns Company ABC” from the output logical expression SR “resign (Steve, Company ABC)”. The generation unit 26 outputs the answer sentence KB “Steve resigns Company ABC” to the output unit 27.

Step ST27: When the answer sentence KB “Steve resigns Company ABC” is output from the generation unit 26 in step ST26, the output unit 27 outputs the answer sentence KB “Steve resigns Company ABC” to the user.

### Effects of Second Embodiment

According to the information processing apparatus 2 of the second embodiment, even if the question sentence SB is the “interrogative sentence”, similarly to the information processing apparatus 1 of the first embodiment in which the question sentence SB is the “affirmative sentence”, it is possible to give the answer sentence KB to the user without asking back the user in order to obtain the answer sentence KB for the question sentence SB from the user.

<Modification>

In step ST24 described above, the extraction unit 23 extracts a solution AN “X=0” indicating that there is no solution AN having a specific content, instead of the solution AN (for example, the above solution AN (X=Steve)) having a specific content related to the search logical expression KR “resign (X, Company ABC)”. The extraction unit 23 outputs the search logical expression KR “resign (X, Company ABC)” and the solution AN “X=0” to the generation unit 26 via the construction unit 25.

When the search logical expression KR “resign (X, Company ABC)” and the solution AN “X=0” are output from the extraction unit 23, in step ST26, the generation unit 26 generates, for example, an answer sentence KB “I don't know.” from the search logical expression KR “resign (X, Company ABC)” and the solution AN “X=0”. The generation unit 26 outputs the answer sentence KB “I don't know.” to the output unit 27.

When the answer sentence KB “I don't know.” is output from the generation unit 26, the output unit 27 outputs the answer sentence KB “I don't know.” to the user in step ST27.

<Other Modification>

The information processing apparatus 2 of the second embodiment can also be used, for example, in a machine translation system or a network search system instead of the dialogue system described above.

The inference rule SK stored in the accumulation unit 24 may be added and updated as needed in addition to being stored in advance.

The accumulation unit 24 may be constructed in a form of being connected to a network (for example, a centralized management database system, a distributed management database system), or may be constructed in a form of being not connected to any network (for example, standalone database equipment).

### Third Embodiment

An information processing apparatus according to a third embodiment will be described. Unlike the information processing apparatus 1 of the first embodiment and the information processing apparatus 2 of the second embodiment, the information processing apparatus of the third embodiment performs “abductive inference”.

### Configuration of Third Embodiment

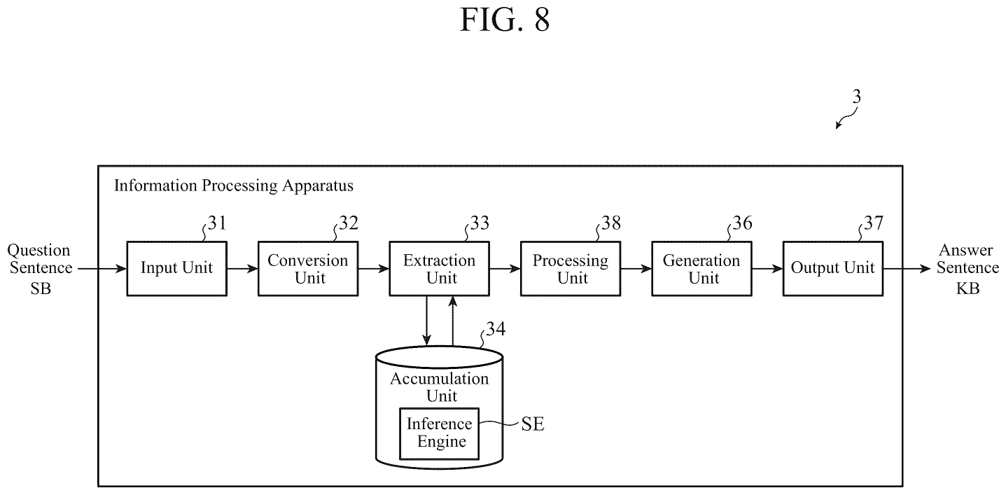

FIG. 8 is a functional block diagram of an information processing apparatus 3 according to the third embodiment.

As illustrated in FIG. 8, the information processing apparatus 3 of the third embodiment includes an input unit 31, a conversion unit 32, an extraction unit 33, an accumulation unit 34, a generation unit 36, and an output unit 37, which are substantially similar to the information processing apparatus 1 (FIG. 1) of the first embodiment.

Here, the input unit 31 corresponds to the input unit 11 of the first embodiment, the conversion unit 32 corresponds to the conversion unit 12 of the first embodiment, the extraction unit 33 corresponds to the extraction unit 13 of the first embodiment, the accumulation unit 34 corresponds to the accumulation unit 14 of the first embodiment, the generation unit 36 corresponds to the generation unit 16 of the first embodiment, and the output unit 37 corresponds to the output unit 17 of the first embodiment.

Unlike the information processing apparatus 1 of the first embodiment, the information processing apparatus 3 of the third embodiment does not include the construction unit 15, but further includes a processing unit 38.

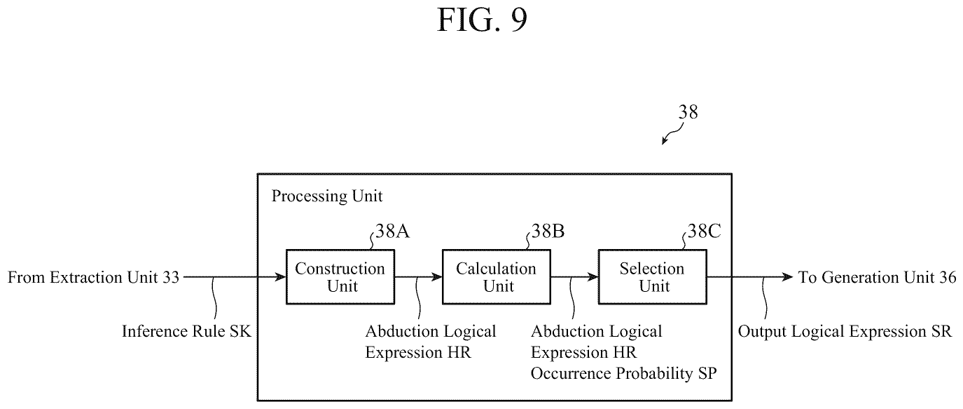

FIG. 9 is a functional block diagram of the processing unit 38 of the third embodiment.

As illustrated in FIG. 9, the processing unit 38 includes a construction unit 38A, a calculation unit 38B, and a selection unit 38C.

The “construction unit 38A” corresponds to a “construction unit”, the “calculation unit 38B” corresponds to a “calculation unit”, and the “selection unit 38C” corresponds to a “selection unit”.

The construction unit 38A generates a plurality of abductive logical expressions HR by substituting a solution AN obtained by collation between the search logical expression KR and the inference rule SK into a plurality of inference rules SK extracted by the extraction unit 33.

The calculation unit 38B calculates a plurality of occurrence probabilities SP. Specifically, each occurrence probability SP is a probability that one word included in each abductive logical expression HR occurs.

The selection unit 38C selects the abductive logical expression HR having the largest occurrence probability SP among the plurality of abductive logical expressions HR as the output logical expression SR on the basis of the plurality of occurrence probabilities SP.

The configuration of the information processing apparatus 3 of the third embodiment is similar to the configuration of the information processing apparatus 1 of the first embodiment (FIG. 2).

### Operation of Third Embodiment

An operation of the information processing apparatus 3 according to the third embodiment will be described.

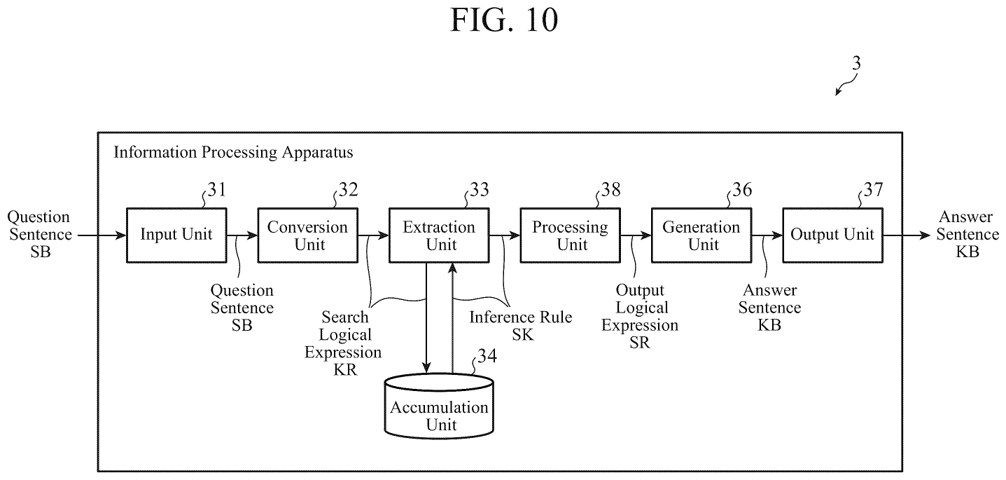

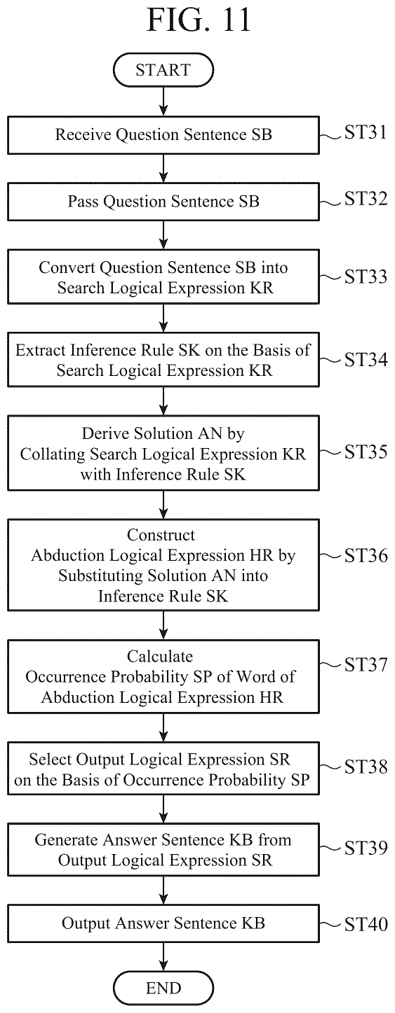

FIG. 10 is a block diagram illustrating the operation of the information processing apparatus 3 according to the third embodiment. FIG. 11 is a flowchart illustrating the operation of the information processing apparatus 3 according to the third embodiment.

Hereinafter, the operation of the information processing apparatus 3 of the third embodiment will be described with reference to the block diagram of FIG. 10 and the flowchart of FIG. 11.

In order to facilitate description and understanding, sentences, logical expressions, and the like are listed in advance below.

Question sentence SB: Steve resigns Company ABC.
Search logical expression KR: resign (Steve, Company ABC)
Inference rule SK (1): sick (X)→resign (X, Y)
Inference rule SK (2): hate (X, Y)→resign (X, Y)
Inference rule SK (3): old (X)→resign (X, Y)
Solution AN (1): X=Steve
Solution AN (2): Y=Company ABC
Abductive logical expression HR (1): sick (Steve)
Abductive logical expression HR(2): hate (Steve, Company ABC)
Abductive logical expression HR (3): old (Steve)
Output logical expression SR: old (Steve)
Answer sentence KB: Steve is old.

Step ST31: The input unit 31 receives an input of a question sentence SB “Steve resigns Company ABC.” from a user.

Step ST32: When the question sentence SB “Steve resigns Company ABC.” is input in step ST31, the input unit 31 passes the question sentence SB “Steve resigns Company ABC.” to the conversion unit 32.

Step ST33: When the question sentence SB “Steve resigns Company ABC.” is delivered from the conversion unit 32 in step ST32, the conversion unit 32 converts the question sentence SB “Steve resigns Company ABC.” into the search logical expression KR “resign (Steve, Company ABC)” under the predicate logic. The conversion unit 32 outputs the search logical expression KR “Steve resigns Company ABC.” to the extraction unit 33.

Step ST34: When the search logical expression KR “resign (Steve, Company ABC)” is output from the conversion unit 32 in step ST33, the extraction unit 33 searches in the accumulation unit 34 on the basis of the search logical expression KR “resign (Steve, Company ABC)”.

Here, unlike the extraction unit 13 of the first embodiment, the extraction unit 33 extracts three inference rules SK in which the atomic logical expression “resign (X, Y)” that symbolizes the search logical expression KR “resign (Steve, Company ABC)” is the “consequence part”, using the abductive inference. The three inference rules SK are the inference rule SK (1) “sick (X)→resign (X, Y)”, the inference rule SK (2) “hate (X, Y)→resign (X, Y)”, and the inference rule SK (3) “old (X)→resign (X, Y)”.

The extraction unit 33 outputs the inference rule SK (1) “sick (X)→resign (X, Y)”, the inference rule SK (2) “hate (X, Y)→resign (X, Y)”, and the inference rule SK (3) “old (X)→resign (X, Y)” to the processing unit 38.

Step ST35: When the inference rule SK (1) “sick (X)→resign (X, Y)”, the inference rule SK (2) “hate (X, Y)→resign (X, Y)”, and the inference rule SK (3) “old (X)→resign (X, Y)” are output from the extraction unit 33 in step ST34, in the processing unit 38, the construction unit 38A collates the search logical expression KR “resign (Steve, Company ABC)” with the consequence part of the inference rule SK (1) “sick (X)→resign (X, Y)”, the consequence part of the inference rule SK (2) “hate (X, Y)→resign (X, Y)”, and the consequence part of the inference rule SK (3) “old (X)→resign (X, Y)” to derive the solutions AN (1) “X=Steve” and AN (2) “Y=Company ABC”.

Step ST36: The construction unit 38A further substitutes the solutions AN (1) “X=Steve” and AN (2) “Y=Company ABC” into the assumption part of the inference rule SK (1) “sick (X)→resign (X, Y)”, the assumption part of the inference rule SK (2) “hate (X, Y)→resign (X, Y)”, and the assumption part of the inference rule SK (3) “old (X)→resign (X, Y)”. As a result, the construction unit 38A constructs the abductive logical expression HR (1) “sick (Steve)”, the abductive logical expression HR (2) “hate (Steve, Company ABC)”, and the abductive logical expression HR (3) “old (Steve)”.

The construction unit 38A outputs the abductive logical expression HR (1) “sick (Steve)”, the abductive logical expression HR (2) “hate (Steve, Company ABC)”, and the abductive logical expression HR (3) “old (Steve) to the calculation unit 38B.

Step ST37: The calculation unit 38B calculates the occurrence probabilities SP of the words included in the abductive logical expression HR (1) “sick (Steve)”, the abductive logical expression HR (2) “hate (Steve, Company ABC)”, and the abductive logical expression HR (3) “old (Steve)”.

More specifically, the calculation unit 38B performs statistical processing on the abductive logical expression HR (1) “sick (Steve)”, the abductive logical expression HR (2) “hate (Steve, Company ABC)”, and the abductive logical expression HR (3) “old (Steve)”, and specifically, calculates the occurrence probability SP of any one of the subject, the predicate, the object, and the like included in each expression.

For example, the calculation unit 38B calculates the occurrence probabilities SP of the words “sick “,” “hate”, and “old”, which are predicates included in the abductive logical expression HR (1)“sick (Steve)”, the abductive logical expression HR (2) “hate (Steve, Company ABC)”, and the abductive logical expression HR (3) “old (Steve)”, for example, with reference to the number of hits as a result of searching for an article or the like on the net.

Hereinafter, it is assumed that the occurrence probability SP of the word “old” included in the abductive logical expression HR (3) “old (Steve)” among the words “sick”, “hate”, and “old” is the highest.

The calculation unit 38B outputs, to the selection unit 38C, the abductive logical expression HR (1) “sick (Steve)”, the abductive logical expression HR (2) “hate (Steve, Company ABC)”, and the abductive logical expression HR (3) “old (Steve)”, and the occurrence probability SP of the word “sick”, the occurrence probability SP of the word “hate”, and the occurrence probability SP of the word “old”.

Step ST38: The selection unit 38C selects one having the largest occurrence probability SP from among the abductive logical expressions HR (1) “sick (Steve)”, HR (2) “hate (Steve, Company ABC)”, and HR (3) “old (Steve)” on the basis of the occurrence probability SP of the word “sick”, the occurrence probability SP of the word “hate”, and the occurrence probability SP of the word “old”. As described above, since the occurrence probability SP of the word “old” is the largest, the selection unit 38C selects the abductive logical expression HR (3) “old (Steve)”.

The selection unit 38C outputs the abductive logical expression HR (3) “old (Steve)” to the generation unit 36 as the output logical expression SR, that is, as the output logical expression SR “old (Steve)”.

Step ST39: When the output logical expression SR “old (Steve)” is output from the selection unit 38C in step ST38, the generation unit 36 generates the answer sentence KB “Steve is old.” from the output logical expression SR “old (Steve)”. The generation unit 36 outputs the answer sentence KB “Steve is old.” to the output unit 37.

Step ST40: When the answer sentence KB “Steve is old.” is output from the generation unit 36 in step ST39, the output unit 37 outputs the answer sentence KB “Steve is old.” to the user.

### Effects of Third Embodiment

According to the information processing apparatus 3 of the third embodiment, the extraction unit 33 extracts the plurality of inference rules SK by searching in the accumulation unit 34 on the basis of the search logical expression KR.

The processing unit 38 generates the plurality of abductive logical expressions HR from the plurality of inference rules SK. The processing unit 38 also calculates the occurrence probability SP of the word for the plurality of abductive logical expressions HR. The processing unit 38 further selects one abductive logical expression HR among the plurality of abductive logical expressions HR as the output logical expression SR on the basis of the occurrence probabilities SP of the plurality of abductive logical expressions HR.

As a result, similarly to the information processing apparatus 1 of the first embodiment and the information processing apparatus 2 of the second embodiment, it is possible to give the answer sentence KB to the user without asking back the user to obtain the answer sentence KB for the question sentence SB from the user.

<Modification>

The information processing apparatus 3 of the third embodiment can also be used, for example, in a machine translation system or a network search system instead of the dialogue system described above.

The inference rule SK stored in the accumulation unit 34 may be added and updated as needed in addition to being stored in advance.

The accumulation unit 34 may be constructed in a form of being connected to a network (for example, a centralized management database system, a distributed management database system), or may be constructed in a form of being not connected to any network (for example, standalone database equipment).

### Fourth Embodiment

An information processing apparatus according to a fourth embodiment will be described. The information processing apparatus according to the fourth embodiment uses “abductive inference” similarly to the information processing apparatus 3 according to the third embodiment. On the other hand, unlike the information processing apparatus 3 of the third embodiment using the occurrence probability SP of the word, the information processing apparatus of the fourth embodiment uses a co-occurrence probability of a plurality of words.

### Configuration of Fourth Embodiment

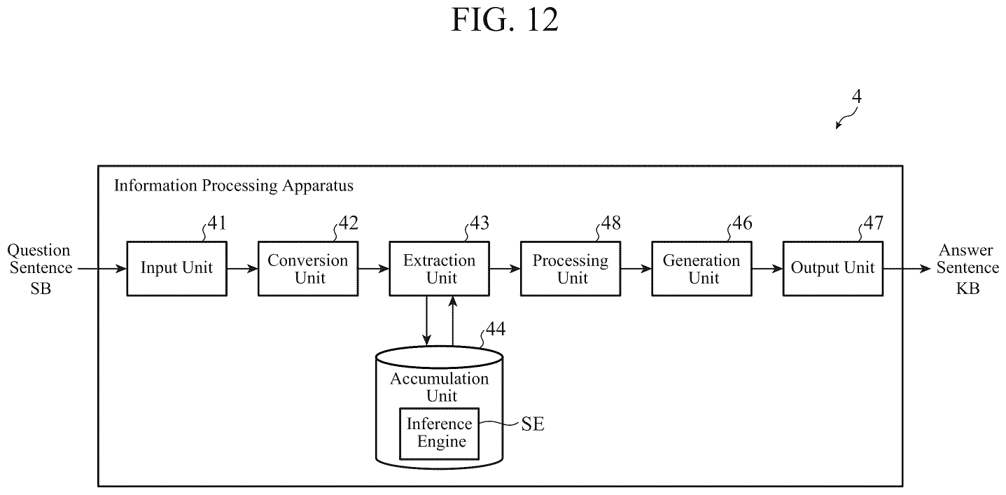

FIG. 12 is a functional block diagram of an information processing apparatus 4 according to the fourth embodiment.

As illustrated in FIG. 12, similarly to the information processing apparatus 3 of the third embodiment, the information processing apparatus 4 of the fourth embodiment includes an input unit 41, a conversion unit 42, an extraction unit 43, an accumulation unit 44, a generation unit 46, an output unit 47, and a processing unit 48.

The input unit 41 corresponds to the input unit 31 of the third embodiment, the conversion unit 42 corresponds to the conversion unit 32 of the third embodiment, the extraction unit 43 corresponds to the extraction unit 33 of the third embodiment, the accumulation unit 44 corresponds to the accumulation unit 34 of the third embodiment, the generation unit 46 corresponds to the generation unit 36 of the third embodiment, and the output unit 47 corresponds to the output unit 37 of the third embodiment.

The function of the processing unit 48 is partially different from the function of the processing unit 38 of the third embodiment.

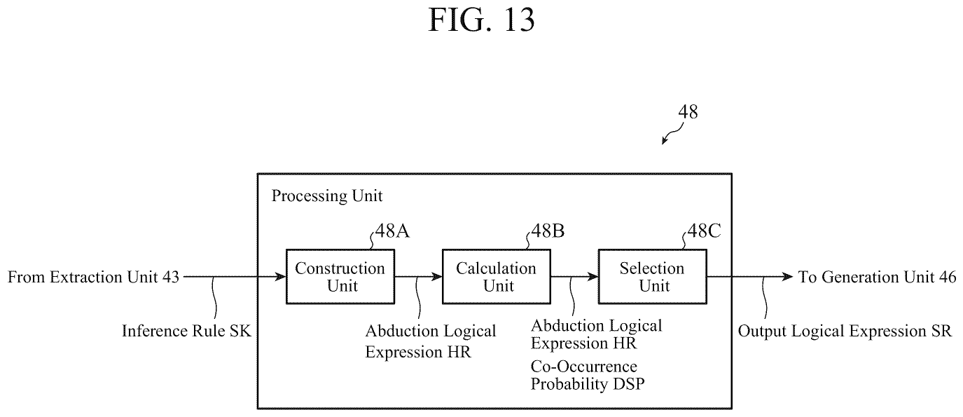

FIG. 13 is a functional block diagram of the processing unit 48 of the fourth embodiment.

As illustrated in FIG. 13, the processing unit 48 includes a construction unit 48A, a calculation unit 48B, and a selection unit 48C.

Similarly to the construction unit 38A of the third embodiment, the construction unit 48A generates a plurality of abductive logical expressions HR by substituting a solution AN obtained by collation between the search logical expression KR and the inference rule SK into a plurality of inference rules SK extracted by the extraction unit 43.

The calculation unit 48B is different from the calculation unit 48B of the third embodiment, and calculates a plurality of co-occurrence probabilities DSP. Each of the co-occurrence probabilities DSP is a probability that a plurality of words included in each of the abductive logical expressions HR co-occur.

Similarly to the selection unit 38C of the third embodiment, the selection unit 48C selects, as the output logical expression SR, an abductive logical expression HR having the largest co-occurrence probability DSP among the plurality of abductive logical expressions HR on the basis of the plurality of co-occurrence probabilities DSP.

The configuration of the information processing apparatus 4 of the fourth embodiment is similar to the configuration of the information processing apparatus 1 of the first embodiment (FIG. 2).

### Operation of Fourth Embodiment

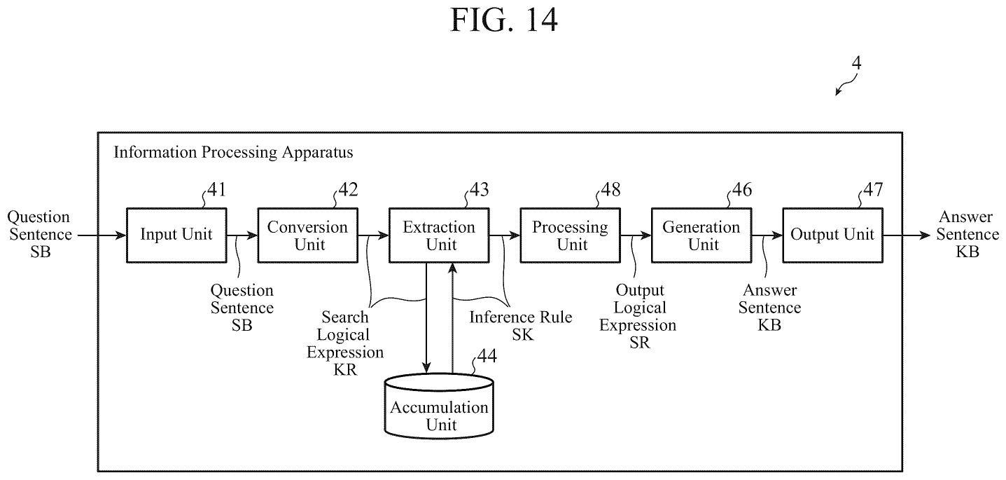

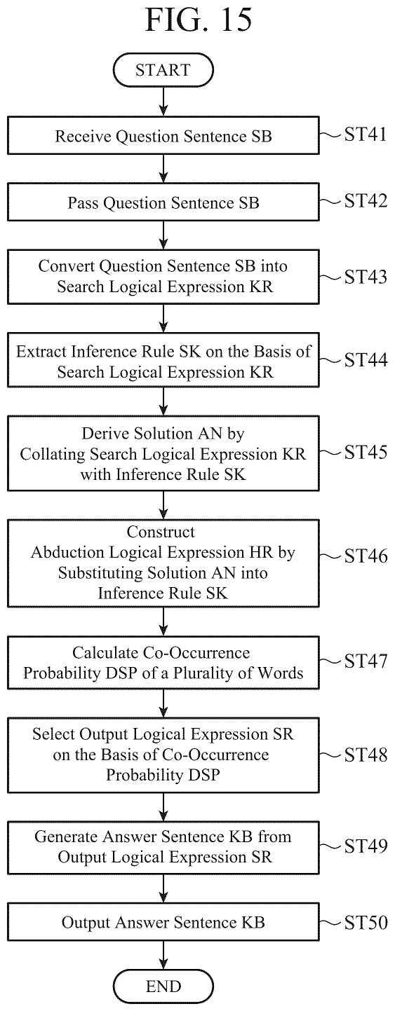

FIG. 14 is a block diagram illustrating an operation of the information processing apparatus 4 according to the fourth embodiment. FIG. 15 is a flowchart illustrating the operation of the information processing apparatus 4 according to the fourth embodiment.

Hereinafter, the operation of the information processing apparatus 4 of the fourth embodiment will be described with reference to the block diagram of FIG. 14 and the flowchart of FIG. 15.

In order to facilitate description and understanding, sentences, logical expressions, and the like are listed in advance below.

Question sentence SB: Steve resigns Company ABC.
Search logical expression KR: resign (Steve, Company ABC)
Inference rule SK (1): sick (X)→resign (X, Y)
Inference rule SK (2): hate (X, Y)→resign (X, Y)
Inference rule SK (3): old (X)→resign (X, Y)
Solution AN (1): X=Steve
Solution AN (2): Y=Company ABC
Abductive logical expression HR (1): sick (Steve)
Abductive logical expression HR(2): hate (Steve, Company ABC)
Abductive logical expression HR (3): old (Steve)
Output logical expression SR: hate (Steve, Company ABC)
Answer sentence KB: Steve hates Company ABC.

Step ST41: The input unit 41 receives an input of a question sentence SB “Steve resigns Company ABC.” from the user, similarly to step ST31 of the third embodiment.

Step ST42: The input unit 41 passes the question sentence SB “Steve resigns Company ABC.” to the conversion unit 42, similarly to step ST32 of the third embodiment.

Step ST43: The conversion unit 42 converts the question sentence SB “Steve resigns Company ABC.” into the search logical expression KR “resign (Steve, Company ABC)” under the predicate logic, similarly to step ST33 of the third embodiment. The conversion unit 42 outputs the search logical expression KR “resign (Steve, Company ABC)” to the extraction unit 43.

Step ST44: The extraction unit 43 searches in the accumulation unit 34 on the basis of the search logical expression KR “resign (Steve, Company ABC)”, similarly to step ST34 of the third embodiment.

Similarly to step ST34 of the third embodiment, the extraction unit 43 extracts three inference rules SK in which an atomic logical expression “resign (X, Y)” that symbolizes the search logical expression KR “resign (Steve, Company ABC)” is a “consequence part”, by using the abductive inference. Similarly to step ST34 of the third embodiment, the three inference rules SK are the inference rule SK (1) “sick (X)→resign (X, Y)”, the inference rule SK (2) “hate (X, Y)→resign (X, Y)”, and the inference rule SK (3) “old (X)→resign (X, Y)”.

The extraction unit 43 outputs the inference rule SK (1) “sick (X)→resign (X, Y)”, the inference rule SK (2) “hate (X, Y)→resign (X, Y)”, and the inference rule SK (3) “old (X)→resign (X, Y)” to the processing unit 48.

Step ST45: In the processing unit 48, similarly to step ST35 of the third embodiment, the construction unit 48A collates the search logical expression KR “resign (Steve, Company ABC)” with the consequence part of the inference rule SK (1) “sick (X)→resign (X, Y)”, the consequence part of the inference rule SK (2) “hate (X, Y)→resign (X, Y)”, and the consequence part of the inference rule SK (3) “old (X)→resign (X, Y)”, to derive the solutions AN (1) “X=Steve” and AN (2) “Y=Company ABC”.

Step ST46: The construction unit 48A further substitutes the solution AN (1) “X=Steve” and the solution AN (2) “Y=Company ABC” into the assumption part of the inference rule SK (1) “sick (X)→resign (X, Y)”, the assumption part of the inference rule SK (2) “hate (X, Y)→resign (X, Y)”, and the assumption part of the inference rule SK (3) “old (X)→resign (X, Y)”, similarly to step ST36 of the third embodiment. As a result, the construction unit 48A constructs the abductive logical expression HR (1) “sick (Steve)”, the abductive logical expression HR (2) “hate (Steve, Company ABC)”, and the abductive logical expression HR (3) “old (Steve)”.

Similarly to step ST36 of the third embodiment, the construction unit 48A outputs the abductive logical expression HR (1) “sick (Steve)”, the abductive logical expression HR (2) “hate (Steve, Company ABC)”, and the abductive logical expression HR (3) “old (Steve) to the calculation unit 38B.

Step ST47: The calculation unit 48B is different from step ST47 of the third embodiment, and calculates the co-occurrence probability DSP of a plurality of words included in the abductive logical expression HR (1) “sick (Steve)”, the abductive logical expression HR (2) “hate (Steve, Company ABC)”, and the abductive logical expression HR (3) “old (Steve)”.

More specifically, the calculation unit 48B calculates a co-occurrence probability DSP that is a probability that each of the predicates “sick”, “hate”, and “old” included in each of the abductive logical expressions HR (1) “sick (Steve)”, HR (2) “hate (Steve, Company ABC)”, and HR (3) “old (Steve)” and an argument “Steve” of each of the expressions co-occur.

The calculation unit 48B calculates the co-occurrence probability DSP of, for example, the abductive logical expression HR (1) “sick (Steve)”, the abductive logical expression HR (2) “hate (Steve, Company ABC)”, and the abductive logical expression HR (3) “old (Steve)”, with reference to, for example, writing on a social networking service (SNS) by Steve himself/herself, and writing on the SNS by a third party other than Steve himself/herself.

Hereinafter, it is assumed that, of the co-occurrence probability DSP of the word “sick” and the word “Steve”, the co-occurrence probability DSP of the word “hate” and the word “Steve”, and the co-occurrence probability DSP of the word “old” and the word “Steve”, the co-occurrence probability DSP of the word “hate” and the word “Steve” is the highest.

For example, it is desirable that the three co-occurrence probabilities DSP are managed in a tabular form and updated in a timely manner. The calculation unit 48B outputs the abductive logical expression HR (1) “sick (Steve)”, the abductive logical expression HR (2) “hate (Steve, Company ABC)”, the abductive logical expression HR (3) “old (Steve)”, and the above-described three co-occurrence probabilities DSP to the selection unit 48C.

Step ST48: Similarly to step ST38 of the third embodiment, the selection unit 48C selects one having the largest co-occurrence probability DSP from among the abductive logical expression HR (1) “sick (Steve)”, the abductive logical expression HR (2) “hate (Steve, Company ABC)”, and the abductive logical expression HR (3) “old (Steve)” on the basis of the above-described three co-occurrence probabilities DSP. As described above, the selection unit 48C selects the abductive logical expression HR (2) “hate (Steve, Company ABC)” because the co-occurrence probability DSP of the word “hate” and the word “Steve” is the largest.

The selection unit 48C outputs the abductive logical expression HR (2) “hate (Steve, Company ABC)” to the generation unit 46 as the output logical expression SR, that is, as the output logical expression SR “hate (Steve, Company ABC)”.

Step ST49: The generation unit 46 generates the answer sentence KB “Steve hates Company ABC.” from the output logical expression SR “hate (Steve, Company ABC)”, similarly to step ST39 of the third embodiment. The generation unit 46 outputs the answer sentence KB “Steve hates Company ABC.” to the output unit 47.

Step ST50: The output unit 47 outputs the answer sentence KB “Steve hates Company ABC.” to the user, similarly to step ST40 of the third embodiment.

### Effects of Fourth Embodiment

According to the information processing apparatus 4 of the fourth embodiment, the extraction unit 43 extracts a plurality of inference rules SK by searching in the accumulation unit 44 on the basis of the search logical expression KR similarly to the third embodiment.

Similarly to the third embodiment, the processing unit 48 generates a plurality of abductive logical expressions HR from the plurality of inference rules SK. Unlike the third embodiment, the processing unit 48 also calculates a co-occurrence probability DSP of a plurality of words for a plurality of abductive logical expressions HR. Similarly to third embodiment, the processing unit 48 further selects one abductive logical expression HR among the plurality of abductive logical expressions HR as the output logical expression SR on the basis of the co-occurrence probability DSP of the plurality of abductive logical expressions HR.

As a result, similarly to the information processing apparatus 3 of the third embodiment, the information processing apparatus 4 of the fourth embodiment can give the answer sentence KB to the user without asking back the user to obtain the answer sentence KB for the question sentence SB from the user.

<Modification>

The information processing apparatus 4 of the fourth embodiment can also be used, for example, in a machine translation system or a network search system instead of the dialogue system described above.

The inference rule SK stored in the accumulation unit 44 may be added and updated as needed in addition to being stored in advance.

The accumulation unit 44 may be constructed in a form of being connected to a network (for example, a centralized management database system, a distributed management database system), or may be constructed in a form of being not connected to any network (for example, standalone database equipment).

### Fifth Embodiment

An information processing apparatus according to a fifth embodiment will be described.

The information processing apparatus according to the fifth embodiment uses “abductive inference” similarly to the information processing apparatus 3 according to the third embodiment.

On the other hand, the information processing apparatus of the fifth embodiment is different from the information processing apparatus 3 or the like of the third embodiment and does not use the occurrence probability SP and the co-occurrence probability DSP.

### Configuration of Fifth Embodiment

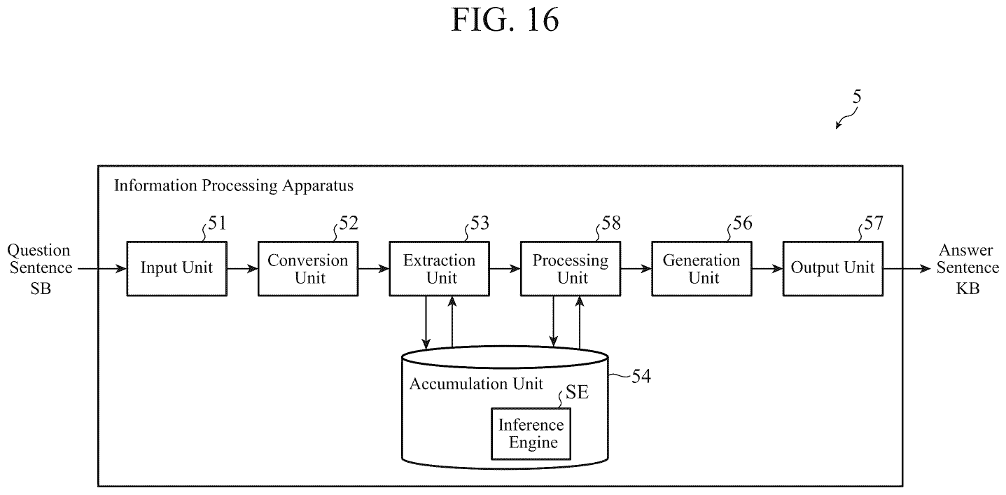

FIG. 16 is a functional block diagram of the information processing apparatus 5 according to the fifth embodiment.

As illustrated in FIG. 16, similarly to the information processing apparatus 3 of the third embodiment, the information processing apparatus 5 of the fifth embodiment includes an input unit 51, a conversion unit 52, an extraction unit 53, an accumulation unit 54, a generation unit 56, an output unit 57, and a processing unit 58.

The input unit 51 corresponds to the input unit 31 of the third embodiment, the conversion unit 52 corresponds to the conversion unit 32 of the third embodiment, the extraction unit 53 corresponds to the extraction unit 33 of the third embodiment, the accumulation unit 54 corresponds to the accumulation unit 34 of the third embodiment, the generation unit 56 corresponds to the generation unit 36 of the third embodiment, and the output unit 57 corresponds to the output unit 37 of the third embodiment.

The function of the processing unit 58 is partially different from the function of the processing unit 38 of the third embodiment.

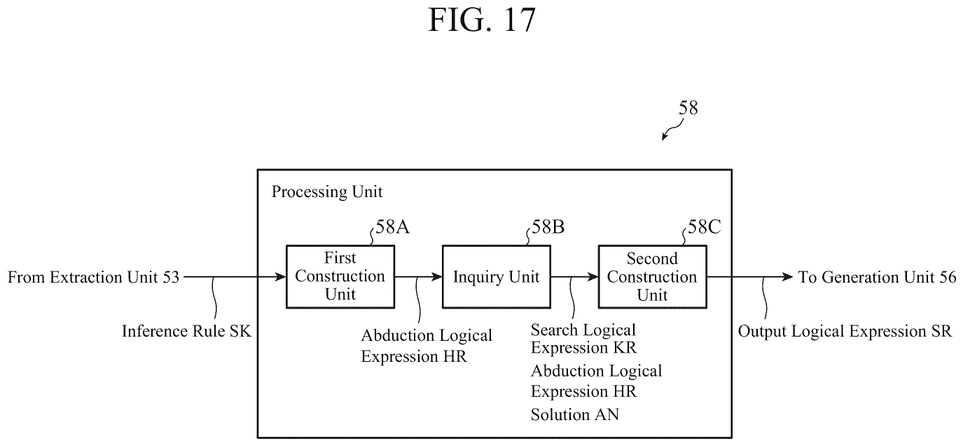

FIG. 17 is a functional block diagram of the processing unit 58 of the fifth embodiment.

As illustrated in FIG. 17, the processing unit 58 includes a first construction unit 58A, an inquiry unit 58B, and a second construction unit 58C.

The “first construction unit 58A” corresponds to a “first construction unit”, the “inquiry unit 58B” corresponds to an “inquiry unit”, and the “second construction unit 58C” corresponds to a “second construction unit”.

The first construction unit 58A generates a plurality of abductive logical expressions HR by substituting one solution AN obtained by collation between a search logical expression KR and a plurality of inference rules SK into the plurality of inference rules SK extracted by the extraction unit 53.

The inquiry unit 58B inquires of the accumulation unit 54 about another solution AN for the plurality of abductive logical expressions HR.

The second construction unit 58C constructs the output logical expression SR from the search logical expression KR, the abductive logical expression HR for which the other solution AN has been obtained, and the other solution AN.

The configuration of the information processing apparatus 5 of the fifth embodiment is similar to the configuration of the information processing apparatus 1 of the first embodiment (FIG. 2).

### Operation of Fifth Embodiment

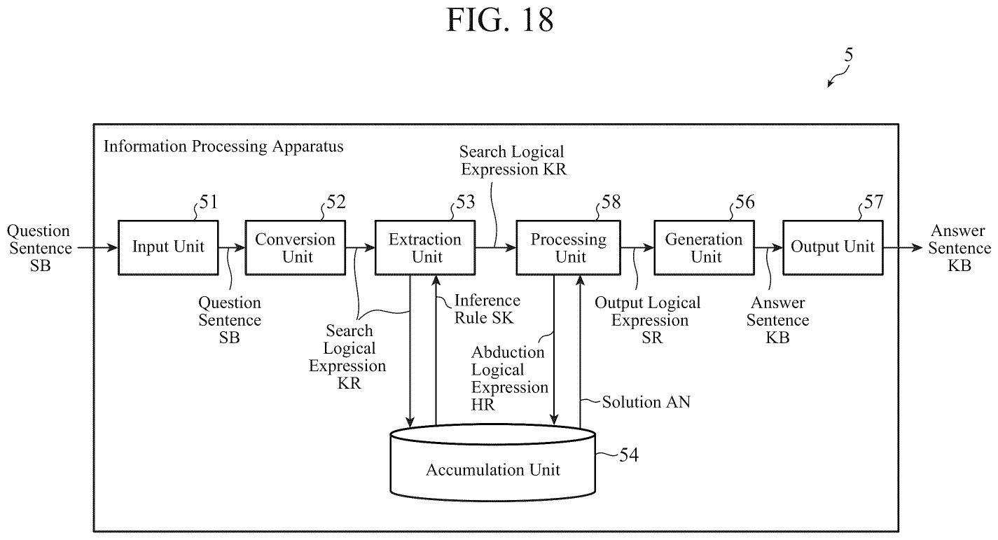

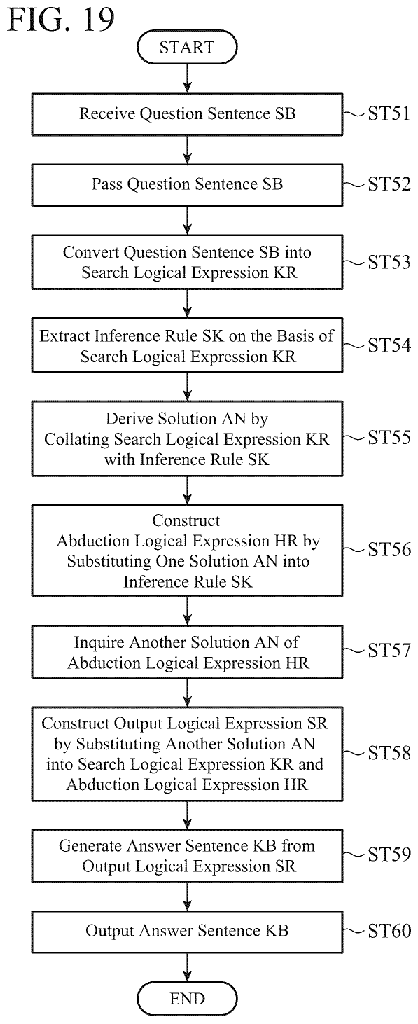

FIG. 18 is a block diagram illustrating an operation of the information processing apparatus 5 according to the fifth embodiment. FIG. 19 is a flowchart illustrating the operation of the information processing apparatus 5 according to the fifth embodiment.

Hereinafter, the operation of the information processing apparatus 5 according to the fifth embodiment will be described with reference to the block diagram of FIG. 18 and the flowchart of FIG. 19.

In order to facilitate description and understanding, sentences, logical expressions, and the like are listed in advance below.

Question sentence SB: Who resigns Company ABC?
Search logical expression KR: resign (X, Company ABC)
Inference rule SK (1): sick (X)→resign (X, Y)
Inference rule SK (2): hate (X, Y)→resign (X, Y)
Inference rule SK (3): old (X)→resign (X, Y)
Solution AN (1): Y=Company ABC
Abductive logical expression HR (1): sick (X)
Abductive logical expression HR (2): hate (X, Company ABC)
Abductive logical expression HR (3): old (X)
Solution AN (2): X=Steve
Output logical expression SR (1): resign (Steve, Company ABC)
Output logical expression SR (2): old (Steve)
Answer sentence KB (1): Steve resigns Company ABC.

Answer sentence KB (2): Steve is old.

Step ST51: The input unit 51 receives an input of the question sentence SB “Who resigns Company ABC?” from a user.

Step ST52: The input unit 51 passes the question sentence SB “Who resigns Company ABC?” to the conversion unit 52.

Step ST53: The conversion unit 52 converts the question sentence SB “Who resigns Company ABC?” into the search logical expression KR “resign (X, Company ABC)” under the predicate logic. The conversion unit 52 outputs the search logical expression KR “resign (X, Company ABC)” to the extraction unit 53.

Step ST54: The extraction unit 53 searches in the accumulation unit 54 on the basis of the search logical expression KR “resign (X, Company ABC)”.

Using the abductive inference, the extraction unit 53 extracts three inference rules SK in which an atomic logical expression “resign (X, Y)” that symbolizes the search logical expression KR “resign (Steve, Company ABC)” is a “consequence part”. Similarly to step ST34 of the third embodiment, the three inference rules SK are the inference rule SK (1) “sick (X)→resign (X, Y)”, the inference rule SK (2) “hate (X, Y)→resign (X, Y)”, and the inference rule SK (3) “old (X)→resign (X, Y)”.

The extraction unit 53 outputs the inference rule SK (1) “sick (X)→resign (X, Y)”, the inference rule SK (2) “hate (X, Y)→resign (X, Y)”, and the inference rule SK (3) “old (X)→resign (X, Y)” to the processing unit 58.

Step ST55: In the processing unit 58, the first construction unit 58A derives a solution AN (1) “Y=Company ABC” by collating the search logical expression KR “resign (X, Company ABC” with the consequence part of the inference rule SK (1) “sick (X)→resign (X, Y)”, the consequence part of the inference rule SK (2) “hate (X, Y)→resign (X, Y)”, and the consequence part of the inference rule SK (3) “old (X)→resign (X, Y)”, similarly to step ST35 of the third embodiment.

Step ST56: The first construction unit 58A substitutes the solution AN (1) “Y=Company ABC” into the assumption part of the inference rule SK (1) “sick (X)→resign (X, Y)”, the assumption part of the inference rule SK (2) “hate (X, Y)→resign (X, Y)”, and the assumption part of the inference rule SK (3) “old (X)→resign (X, Y)”. As a result, the first construction unit 58A constructs the abductive logical expression HR (1) “sick (X)”, the abductive logical expression HR (2) “hate (X, Company ABC”, and the abductive logical expression HR (3) “old (X)”.

Step ST57: The inquiry unit 58B inquires of the accumulation unit 54 about the presence or absence of the specific content of the variable “X” of the three expressions of the abductive logical expression HR (1) “sick (X)”, the abductive logical expression HR (2) “hate (X, Company ABC”, and the abductive logical expression HR (3) “old (X)” and the content thereof.

Here, it is assumed that the accumulation unit 54 has only knowledge about the abductive logical expression HR (3) “old (X)”, and on the other hand, does not have knowledge about the abductive logical expression HR (1) “sick (X)” and knowledge about the abductive logical expression HR (2) “hate (X, Company ABC”.

The inquiry unit 58B acquires the solution AN (2) “X=Steve” from the accumulation unit 54 on the assumption described above. The inquiry unit 58B outputs the search logical expression KR “resign (X, Company ABC)”, the abductive logical expression HR (3) “old (X)”, and the solution AN (2) “X=Steve” to the second construction unit 58C.

Step ST58: The second construction unit 58C substitutes the solution AN (2) “X=Steve” into the search logical expression KR “resign (X, Company ABC)” and the abductive logical expression HR (3) “old (X)”. As a result, the second construction unit 58C constructs the output logical expression SR (1) “resign (Steve, Company ABC)” and the output logical expression SR (2) “old (Steve)”.

The second construction unit 58C outputs the output logical expression SR (1) “resign (Steve, Company ABC)” and the output logical expression SR (2) “old (Steve)” to the generation unit 56.

Step ST59: The generation unit 56 generates the answer sentence KB (1) “Steve resigns Company ABC.” and the answer sentence KB (2) “Steve is old.” from the output logical expression SR (1) “resign (Steve, Company ABC)” and the output logical expression SR (2) “old (Steve)”. The generation unit 56 outputs the answer sentence KB (1) “Steve resigns Company ABC.” and the answer sentence KB (2) “Steve is old.” to the output unit 57.

Here, the generation unit 56 generates the answer sentence KB (1) “Steve resigns Company ABC.” from the output logical expression SR (1) “resign (Steve, Company ABC)” which is an answer corresponding to the search logical expression KR “resign (X, Company ABC)” which is a question, and then generates the answer sentence KB (2) “Steve is old.” from the output logical expression SR (2) “old (Steve)”.

Step ST60: The output unit 57 outputs the answer sentence KB (1) “Steve resigns Company ABC.” and the answer sentence KB (2) “Steve is old.” to the user.

### Effects of Fifth Embodiment

According to the information processing apparatus 5 of the fifth embodiment, the extraction unit 53 extracts the plurality of inference rules SK by searching in the accumulation unit 54 on the basis of the search logical expression KR, similarly to the information processing apparatus 3 or the like of the third embodiment.

Similarly to the third embodiment, the processing unit 58 generates the plurality of abductive logical expressions HR from the plurality of inference rules SK. The processing unit 58 also inquires of the accumulation unit 54 about a solution AN as a specific content for the variable of the abductive logical expression HR. The processing unit 58 further constructs the output logical expression SR from the search logical expression KR, the abductive logical expression HR, and the solution AN.

As a result, similarly to the information processing apparatus 3 or the like of the third embodiment, the information processing apparatus 5 of the fifth embodiment can give the answer sentence KB to the user without asking back the user the information necessary for reaching the output logical expression SR from the question sentence SB in order to obtain the answer sentence KB for the question sentence SB from the user.

<Modification>

The information processing apparatus 5 of the fifth embodiment can also be used, for example, in a machine translation system or a network search system instead of the dialogue system described above.

The inference rule SK stored in the accumulation unit 54 may be added and updated as needed in addition to being stored in advance.

The accumulation unit 54 may be constructed in a form of being connected to a network (for example, a centralized management database system, a distributed management database system), or may be constructed in a form of being not connected to any network (for example, standalone database equipment).

### Sixth Embodiment

An information processing apparatus according to a sixth embodiment will be described.

The information processing apparatus according to the sixth embodiment uses “abductive inference” similarly to the information processing apparatus 3 according to the third embodiment.

On the other hand, the information processing apparatus of the sixth embodiment uses “vectorization” unlike the information processing apparatus 3 or the like of the third embodiment.

### Configuration of Sixth Embodiment

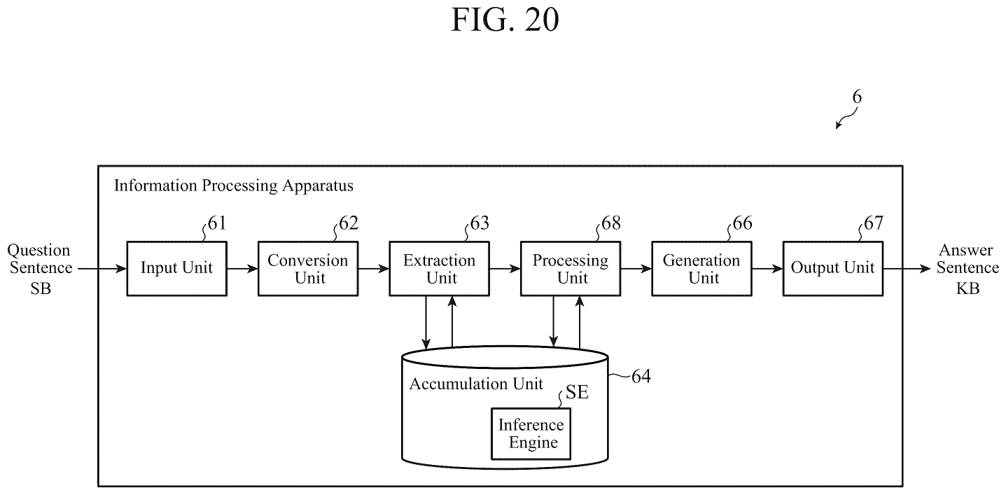

FIG. 20 is a functional block diagram of an information processing apparatus 6 according to the sixth embodiment.

As illustrated in FIG. 20, similarly to the information processing apparatus 3 of the third embodiment, the information processing apparatus 6 of the sixth embodiment includes an input unit 61, a conversion unit 62, an extraction unit 63, an accumulation unit 64, a generation unit 66, an output unit 67, and a processing unit 68.

The input unit 61 corresponds to the input unit 31 of the third embodiment, the conversion unit 62 corresponds to the conversion unit 32 of the third embodiment, the extraction unit 63 corresponds to the extraction unit 33 of the third embodiment, the accumulation unit 64 corresponds to the accumulation unit 34 of the third embodiment, the generation unit 66 corresponds to the generation unit 36 of the third embodiment, and the output unit 67 corresponds to the output unit 37 of the third embodiment.

The function of the processing unit 68 is partially different from the function of the processing unit 38 of the third embodiment.

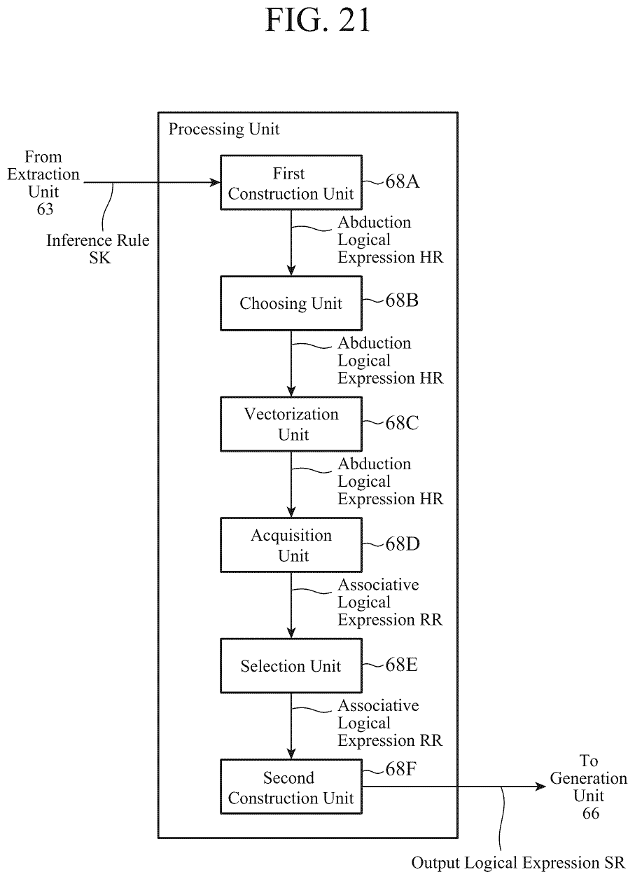

FIG. 21 is a functional block diagram of the processing unit 68 of the sixth embodiment.

As illustrated in FIG. 21, the processing unit 68 includes a first construction unit 68A, a choosing unit 68B, a vectorization unit 68C, an acquisition unit 68D, a selection unit 68E, and a second construction unit 68F.

The “first construction unit 68A” corresponds to a “first construction unit”, the “vectorization unit 68C” corresponds to a “vectorization unit”, the “acquisition unit 68D” corresponds to an “acquisition unit”, and the “second construction unit 68F” corresponds to a “second construction unit”.

The first construction unit 68A constructs the plurality of abductive logical expressions HR by substituting one solution AN obtained by collation between the search logical expression KR and the plurality of inference rules SK into the plurality of inference rules SK extracted by the extraction unit 63.

The choosing unit 68B selects one abductive logical expression HR among the plurality of abductive logical expressions HR on the basis of a lacking amount of the plurality of abductive logical expressions HR and discards the other abductive logical expressions HR.

The vectorization unit 68C vectorizes the one abductive logical expression HR.

The acquisition unit 68D acquires a plurality of associative logical expressions RR in which the distance between the vectors is within a predetermined distance range on the basis of the one vectorized abductive logical expression HR.

For example, the selection unit 68E selects one associative logical expression RR under a unique condition (for example, whether or not proper nouns match) among the plurality of associative logical expressions RR.

The second construction unit 68F constructs the output logical expression SR by substituting another solution AN obtained by the collation between the search logical expression KR and the associative logical expression RR into one associative logical expression RR.

The configuration of the information processing apparatus 6 of the sixth embodiment is similar to the configuration of the information processing apparatus 1 of the first embodiment (FIG. 2).

### Operation of Sixth Embodiment

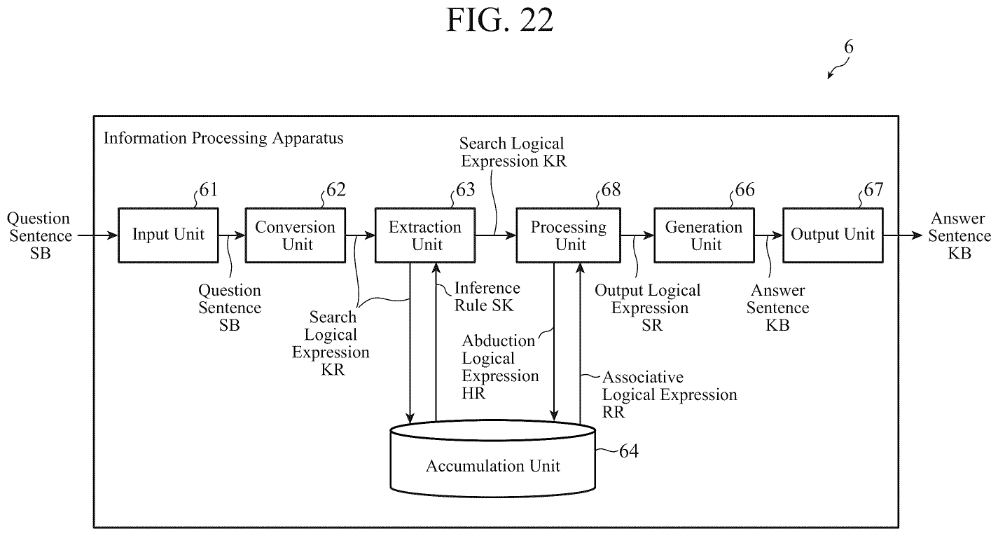

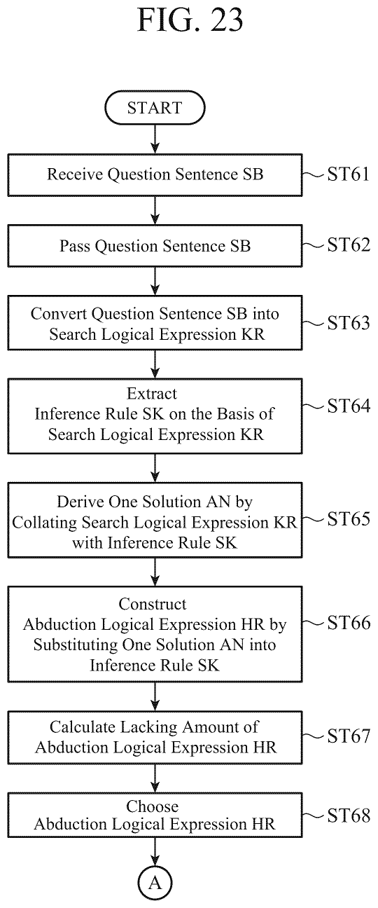

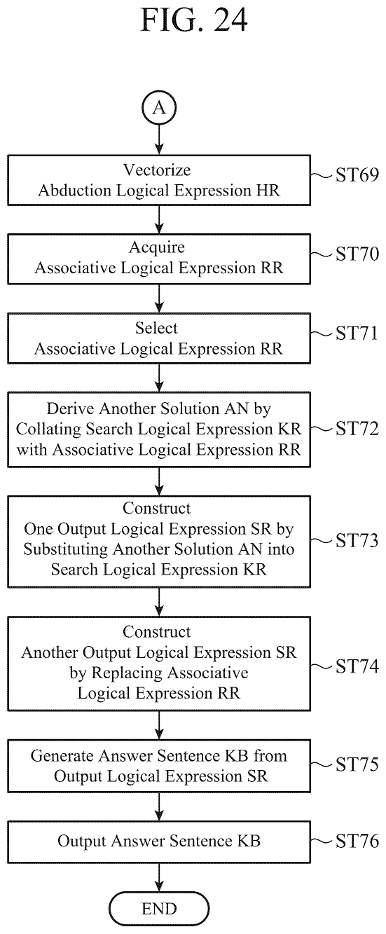

FIG. 22 is a block diagram illustrating an operation of the information processing apparatus 6 according to the sixth embodiment. FIGS. 23 and 24 are flowcharts illustrating the operation of the information processing apparatus 6 according to the sixth embodiment.

Hereinafter, the operation of the information processing apparatus 6 according to the sixth embodiment will be described with reference to the block diagram of FIG. 22 and the flowcharts of FIGS. 23 and 24.

In order to facilitate description and understanding, sentences, logical expressions, and the like are listed in advance below.

Question sentence SB: Who resigns Company ABC?
Search logical expression KR: resign (X, Company ABC)
Inference rule SK (1): sick (X)→resign (X, Y)
Inference rule SK (2): hate (X, Y)→resign (X, Y)
Inference rule SK (3): old (X)→resign (X, Y)
Solution AN (1): Y=Company ABC
Abductive logical expression HR (1): sick (X)
Abductive logical expression HR (2): hate (X, Company ABC)
Abductive logical expression HR (3): old (X)
Associative logical expression RR(1): dislike (Steve, Company ABC)
Associative logical expression RR (2): hate (Tom, Company DEF)
Associative logical expression RR (3): love (Steve, Company DEF)
Solution AN (2): X=Steve
Output logical expression SR (1): resign (Steve, Company ABC)
Output logical expression SR (2): hate (Steve, Company ABC)
Answer sentence KB (1): Steve resigns Company ABC.
Answer sentence KB (2): Steve hates Company ABC.

Step ST61: The input unit 61 receives an input of the question sentence SB “Who resigns Company ABC?” from a user.

Step ST62: The input unit 61 passes the question sentence SB “Who resigns Company ABC?” to the conversion unit 62.

Step ST63: The conversion unit 62 converts the question sentence SB “Who resigns Company ABC?” into the search logical expression KR “resign (X, Company ABC)” under the predicate logic. The conversion unit 62 outputs the search logical expression KR “resign (X, Company ABC)” to the extraction unit 63.

Step ST64: The extraction unit 63 searches in the accumulation unit 54 on the basis of the search logical expression KR “resign (X, Company ABC)”.

Similarly to the extraction unit 53 of the sixth embodiment, the extraction unit 63 extracts three inference rules SK in which an atomic logical expression “resign (X, Y)” that symbolizes the search logical expression KR “resign (Steve, Company ABC)” is a “consequence part”, by using the abductive inference. Similarly to step ST54 of the fifth embodiment, the three inference rules SK are the inference rule SK (1) “sick (X)→resign (X, Y)”, the inference rule SK (2) “hate (X, Y)→resign (X, Y)”, and the inference rule SK (3) “old (X)→resign (X, Y)”.

The extraction unit 63 outputs the inference rule SK (1) “sick (X)→resign (X, Y)”, the inference rule SK (2) “hate (X, Y)→resign (X, Y)”, and the inference rule SK (3) “old (X)→resign (X, Y)” to the processing unit 68.

Step ST65: In the processing unit 68, the first construction unit 68A derives the solution AN (1) “Y=Company ABC” by collating the search logical expression KR “resign (X, Company ABC” with the consequence part of the inference rule SK (1) “sick (X)→resign (X, Y)”, the consequence part of the inference rule SK (2) “hate (X, Y)→resign (X, Y)”, and the consequence part of the inference rule SK (3) “old (X)→resign (X, Y)”, similarly to step ST55 of the fifth embodiment.

Step ST66: The first construction unit 68A also substitutes the solution AN (1) “Y=Company ABC” into the assumption part of the inference rule SK (1) “sick (X)→resign (X, Y)”, the assumption part of the inference rule SK (2) “hate (X, Y)→resign (X, Y)”, and the assumption part of the inference rule SK (3) “old (X)→resign (X, Y)”, similarly to step ST56 of the fifth embodiment. As a result, the first construction unit 68A constructs the abductive logical expression HR (1) “sick (X)”, the abductive logical expression HR (2) “hate (X, Company ABC”, and the abductive logical expression HR (3) “old (X)”.

Step ST67: The choosing unit 68B calculates the lacking amount in each of the abductive logical expression HR (1) “sick (X)”, the abductive logical expression HR (2) “hate (X, Company ABC”, and the abductive logical expression HR (3) “old (X)”. Here, the “lacking amount” refers to a ratio of the number of variables to the number of words for the word (including variable) included in each of the abductive logical expressions HR (1), (2), and (3).

For example, the abductive logical expression HR (1) “sick (X)” has two words “sick” and “X” and has one variable “X”. Therefore, the choosing unit 68B calculates that the lacking amount of the abductive logical expression HR (1) “sick (X)” is “50%”.

Similarly, the choosing unit 68B calculates that the lacking amount of the abductive logical expression HR (2) “hate (X, Company ABC” is “33%” and the lacking amount of the abductive logical expression HR (3) “old (X)” is “50%”.

Step ST68: The choosing unit 68B further discards the abductive logical expression HR (1) “sick (X)”, the abductive logical expression HR (2) “hate (X, Company ABC”, and the abductive logical expression HR (3) “old (X)”.

Here, it is assumed that a predetermined threshold serving as a reference for choosing is “50%”. The choosing unit 68B selects the abductive logical expression HR (2) “hate (X, Company ABC” having a lacking amount “33%” that is less than the threshold “50%”, that is, outputs the abductive logical expression to the vectorization unit 68C in the subsequent stage. On the other hand, the choosing unit 68B discards the abductive logical expression HR (1) “sick (X)” and the abductive logical expression HR (3) “old (X)” having the lacking amount “50%” that is equal to or more than the threshold “50%”, that is, does not output them to the subsequent vectorization unit 68C.

Step ST69: The vectorization unit 68C vectorizes the abductive logical expression HR (2) “hate (X, Company ABC”.

Here, for vectorization (vectorization at 0/1), it is desirable to use a technology of processing a natural language “word2vec”. For example, by vectorizing each of two words by using “word2vec”, the distance between both vectors represents the closeness of the meaning between the two words, that is, the similarity of the meanings.

In the vectorization using “word2vec”, for example, the part of speech of the word and the category to which the word belongs from the viewpoint of the meaning of the word are reflected, in addition to the similarity of the meanings described above.

In the vectorization of the abductive logical expression HR (2) “hate (X, Company ABC” including the variable “X”, it is desirable to clearly distinguish the abductive logical expression HR (2) “hate (X, Company ABC” from a word in a natural language, that is, a word not including a variable. In order to make the distinction, for example, when it is assumed that the length of the word after the vectorization is N, replacement with N 9 (in the case of a decimal number) and N F (in the case of a hexadecimal number) can be adopted.

Step ST70: The acquisition unit 68D acquires, from the accumulation unit 64, the associative logical expression RR in which the distance between the vectors is within a predetermined distance range in relation to the vectorized abductive logical expression HR (2) “hate (X, Company ABC”, in other words, the associative logical expression RR associated from the abductive logical expression HR (2) “hate (X, Company ABC”.

More specifically, the acquisition unit 68D acquires an associative logical expression RR in which the distance between the vectorized abductive logical expression HR (2) “hate (X, Company ABC” and one vectorized associative logical expression RR is within the range of the predetermined distance among the plurality of associative logical expressions RR which have been vectorized in advance using “word2vec” in the accumulation unit 64, that is, on which the associative storage learning has been performed.

The acquisition unit 68D acquires, for example, the associative logical expression RR (1) “dislike (Steve, Company ABC)”, the associative logical expression RR (2) “hate (Tom, Company DEF)”, and the associative logical expression RR (3) “love (Steve, Company DEF)”.

Here, the associative logical expression RR (1) “dislike (Steve, Company ABC)” is acquired from the fact that the word “dislike” is the same part of speech (verb) as the word “hate” of the abductive logical expression HR (2) “hate (X, Company ABC)” and the meanings are approximate.

The associative logical expression RR (2) “hate (Tom, Company DEF)” and the associative logical expression RR (3) “love (Steve, Company DEF)” are acquired from the fact that the word “Company DEF” approximates the word “Company ABC” of the abductive logical expression HR (2) “hate (X, Company ABC)” as a company name.

Step ST71: The selection unit 68E selects one of the associative logical expression RR (1) “dislike (Steve, Company ABC)”, the associative logical expression RR (2) “hate (Tom, Company DEF)”, and the associative logical expression RR (3) “love (Steve, Company DEF)”.

More specifically, the selection unit 68E selects the associative logical expression RR (1) “dislike (Steve, Company ABC)” from the viewpoint of whether or not proper nouns (for example, personal name, company name) match in relation to the abductive logical expression HR (2) “hate (X, Company ABC)”.

Step ST72: The second construction unit 68F derives the solution AN (2) “X=Steve” by collating the search logical expression KR “resign (X, Company ABC)” with the associative logical expression RR (1) “dislike (Steve, Company ABC)”.

Step ST73: The second construction unit 68F constructs the output logical expression SR by substituting the solution AN (2) “X=Steve” into the search logical expression KR “resign (X, Company ABC”, that is, constructs the output logical expression SR (1) “resign (Steve, Company ABC)”.

Step ST74: The second construction unit 68F replaces the word “dislike” of the associative logical expression RR (1) “dislike (Steve, Company ABC)” with the word “hate” of the abductive logical expression HR (2) “hate (X, Company ABC)”. As a result, the second construction unit 68F constructs the output logical expression SR, that is, constructs the output logical expression SR (2) “hate (Steve, Company ABC)”.

The second construction unit 68F outputs the output logical expression SR (1) “resign (Steve, Company ABC)” and the output logical expression SR (2) “hate (Steve, Company ABC)” to the generation unit 66.

Step ST75: The generation unit 66 generates the answer sentence KB (1) “Steve resigns Company ABC.” and the answer sentence KB (2) “Steve hates Company ABC.” from the output logical expression SR (1) “resign (Steve, Company ABC)” and the output logical expression SR (2) “hate (Steve, Company ABC)”.

The generation unit 66 outputs the answer sentence KB (1) “Steve resigns Company ABC.” and the answer sentence KB (2) “Steve hates Company ABC.” to the output unit 67.

Here, the output logical expression SR (1) “resign (Steve, Company ABC)” is a specific content of the search logical expression KR “resign (X, Company ABC)”, that is, a corresponding answer. In addition, the output logical expression SR (2) “hate (Steve, Company ABC)” is a content that supplements the output logical expression SR (1) “resign (Steve, Company ABC)”. Therefore, the generation unit 66 first generates the answer sentence KB (1) “Steve resigns Company ABC.”, and then generates the answer sentence KB (2) “Steve hates Company ABC.”.

Step ST76: The output unit 67 outputs the answer sentence KB (1) “Steve resigns Company ABC.” and the answer sentence KB (2) “Steve hates Company ABC.” to the user.

### Effects of Sixth Embodiment

According to the information processing apparatus 6 of the sixth embodiment, the extraction unit 63 extracts a plurality of inference rules SK by searching in the accumulation unit 64 on the basis of the search logical expression KR, similarly to the information processing apparatus 3 or the like of the third embodiment.

The processing unit 68 also vectorizes one abductive logical expression HR in which the lacking amount does not exceed the threshold among the plurality of abductive logical expressions HR constructed from the plurality of inference rules SK.

The processing unit 68 further acquires an associative logical expression RR associated from the one vectorized abductive logical expression HR.

As a result, similarly to the information processing apparatus 3 or the like of the third embodiment, the information processing apparatus 6 of the sixth embodiment can give the answer sentence KB to the user without asking back the user the information necessary for reaching the output logical expression SR from the question sentence SB in order to obtain the answer sentence KB for the question sentence SB from the user.

<Modification>

The information processing apparatus 6 of the sixth embodiment can also be used in, for example, a machine translation system or a network search system instead of the dialogue system described above.

The inference rule SK stored in the accumulation unit 64 may be added and updated as needed in addition to being stored in advance.

The accumulation unit 64 may be configured in a form of being connected to a network (for example, a centralized management database system, a distributed management database system), or may be configured in a form of being not connected to any network (for example, standalone database equipment).

### REFERENCE SIGNS LIST

1: information processing apparatus, 11: input unit, 12: conversion unit, 13: extraction unit, 14: accumulation unit, 15: construction unit, 16: generation unit, 17: output unit, 2: information processing apparatus, 21: input unit, 22: conversion unit, 23: extraction unit, 24: accumulation unit, 25: construction unit, 26: generation unit, 27: output unit, 3: information processing apparatus, 31: input unit, 32: conversion unit, 33: extraction unit, 34: accumulation unit, 36: generation unit, 37: output unit, 38: processing unit, 38A: construction unit, 38B: calculation unit, 38C: selection unit, 4: information processing apparatus, 41: input unit, 42: conversion unit, 43: extraction unit, 44: accumulation unit, 46: generation unit, 47: output unit, 48: processing unit, 48A: construction unit, 48B: calculation unit, 48C: selection unit, 5: information processing apparatus, 51: input unit, 52: conversion unit, 53: extraction unit, 54: accumulation unit, 56: generation unit, 57: output unit, 58: processing unit, 58A: first construction unit, 58B: inquiry unit, 58C: second construction unit, 6: information processing apparatus, 61: input unit, 62: conversion unit, 63: extraction unit, 64: accumulation unit, 66: generation unit, 67: output unit, 68: processing unit, 68A: first construction unit, 68B: choosing unit, 68C: vectorization unit, 68D: acquisition unit, 68E: selection unit, 68F: second construction unit, SE: inference engine, SB: question sentence, KB: answer sentence, KR: search logical expression, SK: inference rule, SR: output logical expression, HR: abductive logical expression, RR: associative logical expression, AN: solution, SP: occurrence probability, DSP: co-occurrence probability, N: input unit, P: processor, S: output unit, M: memory, K: storage medium, PR: program, DB: database

1.-6. (canceled)

7. An information processing apparatus comprising processing circuitry
to acquire a question sentence,
to convert the question sentence acquired into a search logical expression described by predicate logic,
to extract a plurality of inference rules related to the search logical expression by using the search logical expression,
to construct a plurality of abductive logical expressions by substituting one solution obtained by collation between the search logical expression and the plurality of inference rules into the plurality of inference rules,
to vectorize one abductive logical expression among the plurality of abductive logical expressions,
to acquire, among a plurality of associative logical expressions on which associative memory training has been performed, an associative logical expression associated from the one abductive output logical expression vectorized,
to construct an output logical expression by substituting another solution obtained by collation between the search logical expression and the associative logical expression into the associative logical expression, and
a generation unit to generate an answer sentence from the output logical expression.

8. (canceled)

9. An information processing method executed by a computer comprising:
acquiring a question sentence;
converting the question sentence acquired into a search logical expression described by predicate logic;
extracting a plurality of inference rules related to the search logical expression by using the search logical expression;
constructing a plurality of abductive logical expressions by substituting one solution obtained by collation between the search logical expression and the plurality of inference rules into the plurality of inference rules;
vectorizing one abductive logical expression among the plurality of abductive logical expressions;
acquiring, among a plurality of associative logical expressions on which associative memory training has been performed, an associative logical expression associated from the one abductive output logical expression vectorized;
constructing an output logical expression by substituting another solution obtained by collation between the search logical expression and the associative logical expression into the associative logical expression; and
generating an answer sentence from the output logical expression.
